(19) United States
(12) Patent Application Publication
(10) Pub. No.: US 2023/0072912 A1
(43) Pub. Date: Mar. 9, 2023

(54) NONENZYMATIC ELECTROCHEMICAL SENSORS

(71) Applicant: UNIVERSITY OF COLOMBO, Colombo (LK)

(72) Inventors: Migelhewa Nidarsha KAUMAL, Colombo (LK); Lokuketagodage Hasini Rangika PERERA, Colombo (LK); Gardhi Hettiarachchige Chamari Madhu HETTIARACHCHI, Colombo (LK); Herath Hitihamy Appuhamilage Manisha Ruvini RUVINI, Colombo (LK); Kuluni Madushika PERERA, Colombo (LK)

(21) Appl. No.: 17/794,478

(22) PCT Filed: Jan. 20, 2021
(86) PCT No.: PCT/IB2021/050407

§ 371 Date: Jul. 21, 2022

(30) Foreign Application Priority Data
Jan. 21, 2020 (GB) 2000881.9

(51) Int. Cl. B01L 3/00; G01N 27/327

(52) U.S. Cl. CPC B01L 3/502715; G01N 27/3277; B01L 2300/0645; B01L 2200/16; B01L 2300/123

(57) ABSTRACT

There are provided nonselective, nonenzymatic electrochemical sensor systems for detection and/or measurement of a redox-active analyte in a liquid sample. Sensor systems comprise a nonenyzmatic electrode system having a working electrode, a counter electrode, and a reference electrode, where the working electrode comprises a nonenzymatic modifier selected to increase sensitivity and/or selectivity of the working electrode for an analyte. Sensor systems are wearable, washable and reusable, and can be used for detection of multiple analytes in a sample.

### FIELD

The disclosure relates to electrochemical sensors, sensor systems, and articles of manufacture thereof, particularly for the detection of chemical analytes in liquids.

### BACKGROUND

The field of wearable sensors has developed substantially in recent years with the production of devices capable of performing highly-sensitive electrochemical analysis. Such devices have wide application in healthcare, where they augment conventional physical measurements such as heart rate, EEG, ECG, etc., with the potential to provide added dimensions of information to the wearer in a timely manner. Such sensors are capable of forming part of a biotelemetry system that relays pertinent physiological or environmental information to the wearer in real-time. Through integration into fabrics, textiles and personal electronic devices, these systems provide sensors that users can wear and forget without discomfort or distraction.

Recent developments in electrochemical sensors have focused on convenience, comfort, small size, simplicity of operation, flexibility, and the timely presentation of results. Wearable electrochemical sensors have been integrated onto both textile materials and directly on the epidermis for various monitoring applications owing to their unique ability to process chemical analytes in a non-invasive and non-obtrusive fashion. In this manner, analyte detection can be performed, in real time, to determine the physiological health of the wearer or to identify potential offenders in their environment. For example, various medical conditions of patients need regular or frequent patient-operated testing to monitor conditions and well-being. One example of such patient-operated testing is measuring glucose levels in patients with diabetes.

In the development of wearable sensing devices, electrochemical systems have changed from traditional rigid and planar substrates to flexible, wearable, and conformal sheets. It is desirable to use systems that can be bent and stretched repeatedly so as to withstand the rigors of prolonged body based wear. Optimally such wearable sensors would maintain their sensing capabilities under the demands of normal wear, which can impose severe mechanical deformation of the underlying garment or substrate. These requirements for robustness and resiliency impart additional constraints on electrochemical sensors such as preservation of the sensing area, effective entrapment of the bio-recognition element, and minimizing leaching and potential sources of interference (for review, see Windmiller, J. R. and Wang, J., Electroanalysis 2013, 25(1): 29-46). Fiber based flexible electronics also present exciting possibilities for flexible circuits, skin-like pressure sensors, and other devices in contact with the human body. Applications of wearable sensor technology include military garment devices, biomedical and antimicrobial textiles, and personal electronics. These fiber based wearable electronics have also been applied in the areas of healthcare, environmental monitoring, displays and human—machine interactivity, energy conversion, management and storage, and communication and wireless networks (Zeng, W. et al., Advanced Material 2014, 26: 5310-5336).

Conventional electrochemical sensors use amperometry, in which current is measured between working and counter electrodes, at a constant potential, applied between the working and reference electrodes. Available amperometric sensors use enzymes to catalyze a redox reaction in the presence of an analyte, thereby generating the measured current. However, available enzyme-based systems have significant limitations. Since the enzymes are selective for particular target analytes, the sensors cannot be easily retooled to detect different analytes, and are not easily used to detect multiple analytes. Detection of additional analytes generally requires fabrication of a new sensor containing a new enzyme specific for the new analyte of interest. Further, enzymes are often sensitive to washing and detergents, which limits their reusability. Enzymes can also be expensive and may be sensitive to certain manufacturing methods.

Numerous methods for the determination of estrogens and progesterone in commercial formulations have been reported, including for example spectrophotometric methods, chromatographic methods, and electro-chemical methods (Lee, M. et al., J. Mat. Chem. B 2013, 00: 1-3; Li, C., Bioelectrochem. 2007, 70: 263-8; de Lima, C. A. and Spinelli, A., Electro. Chimica Acta. 2013, 107: 542-8). However, there is a need for nonenzymatic electrochemical sensors that can be used for the detection of hormones such as those associated with the menstrual cycle.

### SUMMARY

The present technology is directed to nonenzymatic electrochemical sensor systems (ESS) for detection and/or measurement of one or more chemical analyte in a liquid sample. There are provided ESS comprising a nonenyzmatic electrode system that includes at least one working electrode (WE), at least one counter electrode (CE), and a reference electrode. Based on the analytes targeted in the sample, the WE can be modified with a suitable nonenzymatic modifier to achieve higher sensitivity. The nonenyzmatic electrode system can detect the amounts of various redox-active compounds in liquids at potentials specific to each compound.

The ESS provided herein uses a nonselective electrochemical signal to detect redox-active compounds. The ESS can thus be used to detect and/or measure a wide range of redox-active compounds in a sample, at a selected potential for each redox-active compound (the selected potential being the potential under which the redox-active compound is oxidized or reduced). The ESS produces a current (the current is produced at the working electrode (WE)) that is proportional to the amount of redox-active compound (i.e., target analyte) in a sample. The total amount of redox-active compound or the current produced at a given potential (each redox-active compound being oxidized or reduced at a specific potential) is used as a signal to detect and/or measure the redox-active compound in a sample. This characteristic means that the ESS can be set to produce current at a first electric potential and used to detect or measure a first redox-active compound that produces current at the first electric potential, after which the ESS can be set to produce current at a second electric potential and then used to detect or measure a second redox-active compound that produces current at the second electric potential. In this way, the ESS can easily be used and re-used multiple times to detect or measure multiple redox-active compounds. Further, by including multiple electrodes which are each active at a different potential, an ESS can be used to detect and/or measure multiple redox-active compounds in a sample.

It should be understood that an ESS can be used to measure many different analytes simply by changing the electric potential (the applied potential or the accumulation potential). By way of example, in an embodiment a nonenzymatic modifier is used to accumulate redox-active compounds on the working electrode. Accumulating potential and applied potential (oxidizing/reducing potential) can be varied in order to obtain selectivity for different sets of compounds using the same working electrode. At a given positive potential, the ESS can oxidize compounds that can undergo oxidation at a lesser potential than the supplied positive potential value; similarly, at a negative potential, the ESS can reduce compounds that can undergo reduction at a lesser potential than the supplied positive potential. This allows detection of a selected set of redox-active compounds simply by varying the applied potential. It will be appreciated that in this way the ESS can be easily and rapidly switched between applications by targeting different analytes simply by changing the electric potential. The ESS is thus reusable, with one ESS being capable of use in many different applications.

By way of example, which is not meant to be limiting, consider three compounds A, B, and C that can undergo oxidation at +0.35 V, +0.65 V and +0.8 V, respectively. For detection at +0.4 V, only A will be oxidized and the response level of the ESS will be proportional to the amount of A in the sample; for detection at +0.7 V, both A and B will be oxidized and the response level of the ESS will be proportional to the amount of total A and B in the sample; for detection at +0.9 V, A, B and C will be oxidized and the response level of the ESS will be proportional to the amount of total A, B and C. Similarly, it will be understood that detection of a selected set of redox-active compounds may be achieved by varying the accumulation potential, as some compounds can be accumulated onto the working electrode selectively by varying the accumulation potential.

Further, as the ESS measures variation of total redox substances in a sample at a given electric potential, it can provide a measure of total redox potential for the sample at the given potential.

Without wishing to be limited by theory, it is believed that, since the ESS does not rely on enzymes and enzymatic modifiers, it provides a nonselective sensor that can be used to target any chemical analyte in any liquid sample by adjusting the potential. Further, it can be used on any substrate, including e.g. non-flexible, hard, flexible, or soft substrates, to detect or measure redox-active compounds. Since the ESS is nonselective and uses only nonenzymatic modifiers, it is generally reusable. In addition, in many embodiments provided herein, the ESS is washable as well. In many embodiments provided herein, the ESS is non-invasive. In many embodiments provided herein, the ESS is wearable. In some cases, a suitable nonenzymatic modifier, such as without limitation a surfactant, may be used on a WE to increase the sensitivity for a target analyte. In such cases, the nonenzymatic modifier may be changed after first use, if it is desired to increase sensitivity for a second, different target analyte. The ESS is thus highly flexible and adaptable to a wide range of target analytes and samples, and capable of broad application.

In a first aspect, there is provided a nonenzymatic electrochemical sensor system (ESS) for the detection and/or measurement of one or more analyte in a sample. The ESS comprises at least one working electrode (WE); at least one counter electrode (CE); and a reference electrode. The ESS does not use enzymes or enzymatic modifiers. In some embodiments, the ESS comprises a nonenzymatic modifier to increase sensitivity for the one or more analyte. The ESS thereby allows nonselective detection of one or more analyte (redox-active compound) in a sample.

In an embodiment, the electrochemical sensor system provided herein is nonselective, for example it can be used to detect or measure a large number of analytes in a sample, e.g., in a bodily fluid.

In some embodiments, the electrochemical sensor system provided herein is non-invasive.

In some embodiments, the electrochemical sensor system provided herein is wearable.

In some embodiments, the electrochemical sensor system provided herein is reusable.

In some embodiments, the electrochemical sensor system provided herein is washable.

In some embodiments, the electrochemical sensor system provided herein is nonselective, non-invasive, wearable, reusable, and/or washable.

In some embodiments of the present technology, the electrochemical sensor system is a biosensor, i.e., a sensor used to detect a biological parameter in a bodily fluid.

In some embodiments, there is provided a nonselective, nonenzymatic electrochemical sensor system (ESS) for detection and/or measurement of an analyte in a sample, the sensor system comprising a substrate; and a nonenyzmatic electrode system disposed on the substrate, the nonenyzmatic electrode system comprising : i) at least one working electrode (WE), the WE being electrochemically inert and conductive in a selected voltage range under which the analyte undergoes oxidation or reduction, the WE being configured to oxidize or reduce the analyte in the selected voltage range and thereby produce a current, the WE comprising a nonenzymatic modifier selected to increase sensitivity and/or selectivity of the WE for the analyte; ii) at least one counter electrode (CE), the CE being electrochemically inert and conductive in the selected voltage range, the CE being configured to complete a current path for the current produced by the WE; and iii) a reference electrode (RE), the RE being electrochemically inert and conductive in the selected voltage range, the RE being configured for use as a reference point; wherein the current produced by the nonenyzmatic electrode system in the selected voltage range is proportional to the amount of the analyte in the sample.

The nonenzymatic modifier is generally selected to increase the sensitivity of the WE for the analyte and may be, for example, a surfactant such as Cetrimonium bromide (CTAB). the nonenzymatic modifier may be applied to the WE in the form of a film, a coating, or as a composite, such as a carbon paste. In an embodiment, the nonenzymatic modifier is applied to the WE in the form of a film, a coating, or as a composite (such as, without limitation, a carbon paste).

In some embodiments, one or more of the WE, the CE and the RE is mixed with an adhesive, such as a glue, such as a conductive glue.

In some embodiments, the WE, the CE and the RE are independently in the form of wires, a sheet, a powder, a powder mixed with an adhesive, or a fabric, fibers, a thread or yarn.

In one embodiment, the WE is knitted or woven into a yarn, a thread, a fiber or a fabric. In some such embodiments, the fabric thread or yarn is itself the working electrode. In some such embodiments, the yarn, thread, fiber or fabric encompassing the WE is then subsequently added to (e.g., sewn into, embedded in) a garment or other wearable article.

In an embodiment, the WE comprises carbon powder, silver powder, silver wire, or a silver sheet; the RE comprises silver wire, stainless steel, or a mixture of silver and silver chloride; and/or the CE comprises carbon powder, silver powder, silver wire, or a silver sheet. In some embodiments, the nonenyzmatic electrode system further comprises a fourth electrode (FE), the FE being electrochemically inert and conductive in the selected voltage range, the FE being configured for electrochemical generation of reagents and/or conditions required for oxidation or reduction of the analyte and/or for optimization of conditions for oxidation or reduction of the analyte. For example, the FE may generate hydroxyl ions. In some embodiments, the FE is used to measure the conductivity of the sample with respect to the RE. In an embodiment, the FE is mixed with an adhesive, such as a glue, a conductive material, or a conductive glue. In an embodiment, the FE is in the form of wires, a sheet, a powder, a powder mixed with an adhesive such as a conductive glue, or a fabric, fibers, a thread or yarn. In an embodiment, the FE comprises carbon powder, silver powder, silver wire, a silver sheet, stainless steel wire, or a stainless steel sheet. In one embodiment, the FE is mixed with a conductive glue.

In an embodiment, the RE comprises a stable metal and salt mixture mixed with conductive glue.

In an embodiment, the nonenyzmatic electrode system comprises two or more WEs, each of the two or more WEs being the same. In another embodiment, the nonenyzmatic electrode system comprises two or more WEs, each of the two or more WEs being configured to detect or measure a different analyte, such that the sensor system can detect and/or measure two or more analytes in the sample. In yet another embodiment, the nonenyzmatic electrode system comprises two or more WEs, each of the two or more WEs comprising a different nonenzymatic modifier and therefore being for detection or measurement of a different analyte, such that the sensor system can detect and/or measure two or more analytes in the sample at the same time. In some embodiments, the two or more WEs each have a different electric potential, each different electric potential being specific for a different analyte, such that the sensor system can detect and/or measure two or more analytes in the sample sequentially within the same measurement cycle. It will be understood by the skilled artisan that generally analytes having lower oxidation electric potential will be measured first, followed by measurement of analytes having higher oxidation electric potentials.

In some embodiments, the substrate comprises a single layer. In other embodiments, the substrate comprises a first layer and a second layer, the first layer having a first nonenyzmatic electrode system disposed thereon, and the second layer having a second nonenyzmatic electrode system. For example, the first nonenyzmatic electrode system may comprise a first working electrode configured to detect or measure a first analyte, and the second electrode system may comprise a second working electrode configured to detect or measure a second analyte. In another embodiment, the substrate comprises a first layer and a second layer, the first layer having a first RE, a first CE, and an FE disposed thereon, and the second layer having a second RE, a second CE, and a WE disposed thereon.

In some embodiments, the analyte is a biomarker, a hormone, a metabolite, glucose, a protein, a peptide, a nucleic acid, an alcohol, an electrolyte, or a low molecular weight chemical compound. In one embodiment, the analyte is a hormone, such as without limitation estrogen, progesterone, a synthetic estrogen such as ethinylestradiol, or a synthetic progestin such as levonorgestrel. In one embodiment, the analyte is cortisol. In one embodiment, the analyte is uric acid.

In some embodiments, the sample is a bodily fluid, e.g., urine, saliva, or sweat.

In some embodiments, the substrate is flexible and/or stretchable. For example, the substrate may be fabric, paper, plastic, silicone, or polyurethane. In some embodiments, the substrate comprises cotton, wool, nylon, polyester, rayon, neoprene, viscose, modal, microfiber, Tencel® and/or Gore-Tex®. In some embodiments, the substrate comprises about 60%, about 70%, about 80%, about 85%, about 90%, about 95%, or 100% cotton, optionally coated at least partially with a hydrophobic substance such as a varnish or thermoplastic polyurethane.

In some embodiments, the electrochemical sensor system (ESS) is fabricated by hand painting, printing (e.g., screen printing), stamping, pasting or stitching the nonenyzmatic electrode system onto the substrate. In some embodiments, the ESS is fabricated by being knitted or woven into a yarn, a thread, a fiber or a fabric. In some such embodiments, the yarn, thread, fiber or fabric encompassing the ESS is then subsequently added to (e.g., sewn into, embedded in) a garment or other wearable article.

In some embodiments, the sensor system is a laminating paper sensor, the WE, CE and/or RE comprising laminating paper. In other embodiments, the sensor system is a wearable cotton sensor wherein the WE and/or the CE comprise cotton fabric.

In some embodiments, the WE comprises graphite-varnish 2:1 paste (w/w); the CE comprises graphite-varnish 2:1 paste (w/w); and/or the RE comprises a conductive Ag ink or Ag fabric pseudo reference electrode. In other embodiments, the WE comprises graphite-(polyurethane-crosslink 2:1) 4:2 paste (w/w); the CE comprises graphite-(polyurethane-crosslink 2:1) 4:4 paste (w/w); and/or the RE comprises an Ag ink or Ag fabric pseudo reference electrode. In an embodiment, the WE comprises CTAB modified graphite-varnish 2:1 paste (w/w) or CTAB modified graphite-(polyurethane-crosslink 2:1) 4:2 paste (w/w). The CTAB may be present for example at a concentration of 0.08, 0.1, 5, or 10 mmol dm⁻³ CTAB. In one embodiment, the CTAB is present at a concentration of 5 mmol dm⁻³.

In some embodiments, the WE, the CE, the RE, and the FE are independently 2 mm wide, 3 mm wide, or 4 mm wide and/or 25 mm long.

In some embodiments, the resistance of the WE and/or the CE is less than 1.0 kΩ/cm.

In some embodiments, the electrochemical sensor system is configured to detect the level of estrogen in a urine sample.

In some embodiments, the electrochemical sensor system is configured to detect the conductivity value in a sweat sample, for example to determine hydration level of a subject.

In some embodiments, the electrochemical sensor system is configured to detect the level of glucose in a saliva sample.

In some embodiments, the electrochemical sensor system and/or the nonenyzmatic electrode system is washable in the presence or absence of a detergent and/or reusable.

In a second broad aspect, there is provided a nonenzymatic electrode system for detection and/or measurement of an analyte in a sample, as described herein. In an embodiment, the nonenyzmatic electrode system comprises : i) at least one working electrode (WE), the WE being electrochemically inert and conductive in a selected voltage range under which the analyte undergoes oxidation or reduction, the WE being configured to oxidize or reduce an analyte in a selected voltage range and thereby produce a current, the WE comprising a nonenzymatic modifier selected to increase sensitivity and/or selectivity of the WE for the analyte; ii) at least one counter electrode (CE), the CE being electrochemically inert and conductive in the selected voltage range, the CE being configured to complete a current path for the current produced by the WE; and iii) a reference electrode (RE), the RE being electrochemically inert and conductive in the selected voltage range, the RE being configured for use as a reference point; wherein the current produced by the nonenyzmatic electrode system in the selected voltage range is proportional to the amount of the analyte in the sample.

In a third broad aspect, there is provided an electrochemical device or an article of manufacture comprising one or more electrochemical sensor system and/or one or more nonenyzmatic electrode system as described herein. Non-limiting examples of devices or articles that may incorporate one or electrochemical sensor system or nonenyzmatic electrode system described herein include medical devices, fitness monitors, personal electronic devices, or glucose monitors. In some embodiments, there are provided wearable items comprising one or more electrochemical sensor system and/or one or more nonenyzmatic electrode system as described herein. Wearable items are generally configured to be worn on a body or on at least one body part of a subject. Non-limiting examples of wearable items include electronically operated devices, articles of apparel, such as garments, e.g., undergarments, flexible compression garments, athletic clothing, etc. In some embodiments, a wearable item further comprises one or more additional sensor configured to sense at least one characteristic associated with movement of the subject and/or at least one physiological characteristic of the subject.

In a fourth broad aspect, there is provided a method of predicting future events, using the ESS to collect data which is then predictive for a known, periodic or cyclical physiological event. As one example, which is not meant to be limiting, methods for detection and/or measurement of an analyte in a sample described herein may be used to detect and/or measure hormones associated with the menstrual cycle in a subject. Once baseline hormone levels throughout the menstrual cycle have been established for a subject, then the methods of the present technology can be used to predict a known or expected event, such as ovulation.

In a fifth broad aspect, there is provided a method of predicting or diagnosing unexpected phsiological events, using the ESS to collect data which is then determinative of an unexpected event. As one example, which is not meant to be limiting, methods for detection and/or measurement of an analyte in a sample described herein may be used to detect and/or measure daily glucose levels in a subject. Once baseline levels have been established for a subject, then the methods of the present technology can be used to detect a sudden fluctuation in glucose levels, which may for example be indicative of the onset of diabetes.

In some embodiments, there is provided a method for detection and/or measurement of an analyte in a sample from a subject, the method comprising the steps of: a) obtaining a first sample that has been isolated from the subject; b) contacting the first sample with the electrochemical sensor system or nonenyzmatic electrode system described herein; c) measuring a first level of the analyte in the first sample using the electrochemical sensor system or the nonenyzmatic electrode system; d) obtaining a second sample that has been isolated from the subject; e) contacting the second sample with the electrochemical sensor system or the nonenyzmatic electrode system; f) measuring a second level of the analyte in the second sample using the electrochemical sensor system or the nonenyzmatic electrode system; g) comparing the second level to the first level to determine if the second level is changed compared to the first level; and h) optionally, alerting the subject if the second level is changed compared to the first level.

In some embodiments, the method further comprises the steps of: i) obtaining a third sample that has been isolated from the subject; j) contacting the third sample with the electrochemical sensor system or the three sensor system; k) measuring a third level of the analyte in the third sample using the electrochemical sensor system; l) comparing the third level to the first level to determine if the third level is changed compared to the first level; and m) optionally, alerting the subject if the third level is changed compared to the first level.

In some embodiments, methods can be used to detect and/or measure more than one analyte in the sample, since the same electrochemical sensor system or three sensor system can be used to detect and/or measure multiple analytes.

In some embodiments, the sample is a bodily fluid such as urine, saliva or sweat.

In some embodiments, the electrochemical sensor system or the nonenyzmatic electrode system is part of a wearable item configured to be worn by or on the subject, such that contact of the first sample, the second sample, and the third sample with the electrochemical sensor system occurs automatically or involuntarily, without a requirement to first isolate the sample from the subject or other active participation by the subject. For example, the wearable item may be an electronically operated device or an article of apparel, e.g., a garment such as an undergarment, a flexible compression garment, or athletic clothing. The substrate may be, for example, fabric, yarn, thread, fiber, paper, plastic, silicone, or polyurethane, e.g., comprising cotton, wool, nylon, polyester, rayon, neoprene, viscose, modal, microfiber, Tencel® and/or Gore-Tex®. In some embodiments, the substrate is a moisture wicking fabric. In some embodiments, the substrate is a moisture absorbing fabric. In an embodiment, the substrate comprises about 60%, about 70%, about 80%, about 85%, about 90%, about 95%, or 100% cotton, optionally coated at least partially with a hydrophobic substance such as a varnish or thermoplastic polyurethane. In an embodiment, the substrate comprises about 60%, about 70%, about 80%, about 85%, about 90%, about 95%, or 100% of a moisture wicking fabric, such as without limitation modal, microfibers, or a fabric treated with a wicking enhancer.

In an embodiment, the substrate comprises about 60%, about 70%, about 80%, about 85%, about 90%, about 95%, or 100%

In an embodiment, the analyte is a hormone, e.g., estrogen, progesterone, a synthetic estrogen such as ethinylestradiol, or a synthetic progestin such as levonorgestrel. In an embodiment, the analyte is cortisol. In an embodiment, the analyte is uric acid.

In some embodiments, the level of the analyte in the subject is detected and/or measured continuously or at regular predetermined intervals, each level being compared to the first level to determine if the level is changed. The regular predetermined intervals may be, for example, hourly, twice a day, daily, weekly, or monthly.

In an embodiment, the step of alerting the subject comprises sending an electronic signal to a mobile communication or a computing device.

In some embodiments, electrochemical sensor systems and/or nonenyzmatic electrode systems are used in methods of monitoring, diagnosis or prognosis of a subject. For example, there are provided methods comprising using the electrochemical sensor system or nonenyzmatic electrode system described herein to establish a baseline level of one or more analyte in a bodily fluid of a subject; measuring the level of the one or more analyte in the bodily fluid of the subject; comparing the measured level to the baseline level to determine whether the level has changed compared to the baseline level; and signaling or alerting the user when the level of the one or more analyte has changed compared to the baseline level. The methods may further comprise measuring the level of the one or more analyte repeatedly, at regular intervals, such as hourly, daily, twice-a-day, weekly, bi-weekly, monthly, etc. or continuously. Changes in the level of the one or more analyte may signal, for example, a predicted known event (such as ovulation in the case of hormones measured during the menstrual cycle) or an unexpected event (such as diabetes in the case of glucose levels in a subject).

In one embodiment, there are provided electrochemical sensor systems and methods for the determination of hormones associated with the menstrual cycle in a bodily fluid of a subject. Such methods may be used, for example, for the detection and/or measurement of estrogen and/or progesterone, e.g., to detect ovulation, menstruation, menopause, pregnancy, and the like.

In an embodiment, there is provided a nonenzymatic electrochemical sensor system (ESS) for the detection and/or measurement of hormones associated with the menstrual cycle. In one embodiment, there is provided a nonenzymatic electrochemical sensor for predicting events associated with the menstruation cycle, comprising the electrochemical sensor system or the nonenyzmatic electrode system described herein, wherein the electrochemical sensor system or the nonenyzmatic electrode system is configured for detection of a hormone such as estrogen, progesterone, a synthetic estrogen such as ethinylestradiol, or a synthetic progestin such as levonorgestrel.

In an aspect, there are provided nonenzymatic electrochemical sensors for the detection of hormones associated with the menstrual cycle. In some embodiments, there is provided a wearable sensor platform which is applicable to garment items for the detection of estrogen and/or progesterone levels associated with the menstrual cycle. In one embodiment, the ESS is a laminating paper sensor. In another embodiment, the ESS is a wearable cotton sensor. It will be appreciated that many other embodiments are possible.

In another aspect, there are provided nonenzymatic electrochemical sensors for the detection of conductivity value in sweat, for the determination of hydration level of a subject. In some embodiments, there is provided a wearable sensor platform which is applicable to garment items for the detection of conductivity values in sweat associated with hydration, dehydration, overhydration, etc. In one embodiment, there is provided a nonenzymatic electrochemical sensor for detecting hydration levels in a subject, comprising the electrochemical sensor system or the nonenyzmatic electrode system described herein, wherein the electrochemical sensor system or the nonenyzmatic electrode system is configured as a conductivity sensor to determine the conductivity value in one or more biological fluid sample from the subject, optionally wherein the biological fluid is sweat.

In an aspect, there are provided nonenzymatic electrochemical sensors for the detection of glucose in saliva. In one embodiment, there is provided a nonenzymatic electrochemical sensor for determining glucose levels in a biological fluid, comprising the electrochemical sensor system or the nonenyzmatic electrode system described herein, wherein the electrochemical sensor system or the nonenyzmatic electrode system is configured as a glucose sensor to determine the glucose levels in one or more biological fluid sample from the subject, optionally wherein the biological fluid is saliva.

Without wishing to be limited by theory, it is believed that electrochemical sensor systems and nonenyzmatic electrode systems provided herein can, in some embodiments, have one or more of the following advantages over conventional sensor systems: wearable; washable (with or without a detergent); reusable; low cost; non-invasive; capable of detecting or measuring multiple analytes at a time; capable of being easily reconfigured for the detection or measurement of different analytes; and/or capable of being configured to collect samples automatically or involuntarily. In some embodiments, sensor systems provided herein have improved washability compared to previous electrochemical sensor systems. In some embodiments, sensor systems provided herein have improved reusability compared to previous electrochemical sensor systems. In some embodiments, sensor systems provided herein can be used for real-time, wear-and-forget monitoring of physicochemical parameters in a subject. For example, sensor systems can be used to determine a baseline for a particular parameter or set of parameters in a subject, against which later measurements of the parameter(s) are compared, so that the parameter(s) is continuously monitored and the subject can be promptly alerted to any changes in the parameter(s). Such systems can allow early detection of physiological changes, monitoring disease progression, determining response to medication, monitoring hormonal changes, tracking stages of the menstrual cycle, tracking hydration levels, tracking glucose levels, and the like.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the invention and to show more clearly how it may be carried into effect, reference will now be made by way of example to the accompanying drawings, which illustrate aspects and features according to embodiments of the present invention, and in which:

FIGS. 1A-1C are schematic diagrams of certain embodiments of an electrochemical sensor system (ESS) of the present technology, FIG. 1A showing one embodiment of single layer ESS 100, FIG. 1B showing one embodiment of single layer ESS 200, and FIG. 1C showing one embodiment of single layer ESS 300.

FIGS. 2A-2D are schematic diagrams of certain embodiments of an electrochemical sensor system (ESS) of the present technology, wherein each of FIGS. 2A-2D shows an embodiment of triple layer ESS 400.

FIGS. 3A-3B are schematic diagrams of certain embodiments of an electrochemical sensor system (ESS) of the present technology, wherein each of FIGS. 3A-3B shows an embodiment of double layer ESS 500.

FIG. 4 is a schematic diagram of ESS 600, in accordance with one embodiment of the present technology.

FIGS. 5A-5C are schematic diagrams of certain embodiments of ESS 100.

FIGS. 6A-6C are schematic diagrams of certain embodiments of a laminating paper sensor of the present technology, wherein: FIG. 6A shows the dimension of nonenyzmatic electrodes (reference electrode (RE), working electrode (WE), and counter electrode (CE)), fabricated on a laminating paper sensor; FIG. 6B shows a basic design of a laminating paper sensor; and FIG. 6C shows a schematic of a basic laminating paper sensor.

FIGS. 7A-7B are schematic diagrams of certain embodiments of a wearable cotton sensor of the present technology, wherein: FIG. 7A shows a schematic of a wearable cotton sensor; and FIG. 7B shows dimensions of the electrodes (reference electrode (RE), working electrode (WE), and counter electrode (CE)) constructed on the wearable cotton sensor.

FIG. 8 shows optimization of CTAB concentration of a working electrode of a laminating paper sensor. Variation of the mean current response at +0.59 V was obtained for blank (0.1 mol dm⁻³ KCl) and ethinylestradiol (≈4 μmol dm⁻³) oxidation at unmodified carbon paste and modified carbon paste working electrodes containing different CTAB concentrations on a laminating paper sensor (CV condition; Eᵢₙᵢₜᵢₐₗ: +0.10 V, E_{middle}: +1.00 V, E_{final}+0.10 V, scan rate: 100 mV s⁻¹).

FIG. 9 shows optimization of 5 mmol dm⁻³ CTAB modified graphite : (polyurethane-crosslink w/w) ratio of working electrode on a wearable cotton sensor. Variation of the mean current response at +0.59 V was obtained for blank (0.1 mol dm⁻³ KCl) and ethinylestradiol (≈4 μmol dm⁻³) at unmodified and 5 mmol dm⁻³ CTAB modified working electrodes on a wearable cotton sensor (LSV conditions; E_{acc}: +0.10 V, t_{acc}: 1 min, Eᵢₙᵢₜᵢₐₗ: −0.10 V, E_{final}: +1.00 V, scan rate: 100 mV s⁻¹).

FIGS. 10A-10B are graphs of mean current (μA) at +0.59 V vs. menstrual cycle day, showing variation of the mean current response at +0.59 V obtained for F1 samples, wherein FIG. 10A shows mean current at +0.59 V obtained for F1 samples on a wearable cotton sensor, and FIG. 10B shows mean current at +0.59 V obtained for F1 samples on a laminating paper sensor (LSV conditions; E_{acc}: +0.10 V, t_{acc}: 1 min, Eᵢₙᵢₜᵢₐₗ: −0.10 V, E_{final}: +1.00 V, scan rate: 100 mV s⁻¹).

FIGS. 11A-11B are graphs of mean current (μA) at +0.59 V vs. sample collection day, showing variation of the mean current response at +0.59 V obtained for SPEC SD morning samples, wherein FIG. 11A shows mean current at +0.59 V obtained for SPEC SD samples on a wearable cotton sensor, and FIG. 11B shows mean current at +0.59 V obtained for SPEC SD samples on a laminating paper sensor (LSV conditions; E_{acc}: +0.10 V, t_{acc}: 1 min, Eᵢₙᵢₜᵢₐₗ: −0.10 V, E_{final}: +1.00 V, scan rate: 100 mV s⁻¹).

FIGS. 12A-12B are graphs of mean current (μA) at +0.59 V vs. sample collection day, showing variation of the mean current response at +0.59 V obtained for SPEC RS morning samples, wherein FIG. 12A shows mean current at +0.59 V obtained for SPEC RS samples on a wearable cotton sensor, and FIG. 12B shows mean current at +0.59 V obtained for SPEC RS samples on a laminating paper sensor (LSV conditions; E_{acc}: +0.10 V, t_{acc}: 1 min, Eᵢₙᵢₜᵢₐₗ: −0.10 V, E_{final}+1.00 V, scan rate: 100 mV s⁻¹).

FIGS. 13A-13B are graphs of mean current (μA) at +0.59 V vs. sample collection day, showing comparison of the mean current response at +0.59 V obtained for morning and evening samples, wherein FIG. 13A shows mean current at +0.59 V obtained for SPEC SD morning and evening samples on a wearable cotton sensor, and FIG. 13B shows mean current at +0.59 V obtained for SPEC RS morning and evening samples on a wearable cotton sensor (LSV conditions; E_{acc}: +0.10 V, t_{acc}1 min, Eᵢₙᵢₜᵢₐₗ: −0.10 V, E_{final}+1.00 V, scan rate: 100 mV s⁻¹).

FIG. 14 is a graph of mean current (μA) at +0.59 V vs. ethinylestradiol concentration, showing variation of the oxidation mean current response at +0.59 V with ethinylestradiol concentration series on a wearable cotton sensor (LSV conditions; E_{acc}: +0.10 V, t_{acct}1 min, Eᵢₙᵢₜᵢₐₗ : −0.10 V, E_{final}: +1.00 V, scan rate: 100 mV s⁻¹).

FIG. 15 is a graph of mean current (μA) at +0.59 V vs. number of washings, showing washing stability of laminating paper sensors with 0.1% detergents. There is shown the variation of the mean current response at +0.59 V obtained for F1 samples at washed laminating paper sensors with 0.1% detergent and fresh (unwashed) laminating paper sensors (LSV conditions; E_{acc}: +0.10 V, t_{acc}: 1 min, Eᵢₙᵢₜᵢₐₗ: −0.10 V, E_{final}: +1.00 V, scan rate: 100 mV s⁻¹).

FIG. 16 is a graph of mean current (μA) at +0.59 V vs. number of washings, showing washing stability of wearable cotton sensors with 0.1% detergents. There is shown the variation of the mean current response at +0.59 V obtained for F1 samples at washed wearable cotton sensors with 0.1% detergents and fresh (unwashed) wearable cotton sensors (LSV conditions; E_{acc}: +0.10 V, t_{acc}: 1 min, Eᵢₙᵢₜᵢₐₗ: −0.10 V, E_{final}: +1.00 V, scan rate: 100 mV s⁻¹).

FIG. 17 is a graph of mean current (μA) at +0.59 V vs. Type of solution, showing electrochemical behavior of the wearable cotton sensor with 0.1% detergent solutions and ≈4 μmol dm-3 ethinylestradiol. There is shown the variation of the mean current response at +0.59 V obtained for different test solutions on the wearable cotton sensor (LSV conditions; E_{acc}: +0.10 V, t_{acc} : 1 min, Eᵢₙᵢₜᵢₐₗ: −0.10 V, E_{final}: +1.00 V, scan rate: 100 mV s⁻¹).

FIGS. 18A-18B are graphs of mean current (μA) at +0.59 V vs. Time interval (h), showing variability of the mean current response at +0.59 V obtained (in test Method 1) for F1 samples, wherein FIG. 18A shows testing reusability of laminating paper sensor using F1 sample, and FIG. 18B shows testing reusability of wearable cotton sensor using F1 sample, in different time intervals (LSV conditions; E_{acc}: +0.10 V, t_{acc}: 1 min, Eᵢₙᵢₜᵢₐₗ: −0.10 V, E_{final}: +1.00 V, scan rate: 100 mV s⁻¹).

FIGS. 19A-19B are graphs of mean current (μA) at +0.59 V vs. Time (h), showing variation of the mean current response at +0.59 V obtained (in test Method 2) for F1 samples, wherein FIG. 19A shows reusability of laminating paper sensor and FIG. 19B shows reusability of wearable cotton sensor, in different time intervals (LSV conditions; Eacc: +0.10 V, t_{acc}: 1 min, Eᵢₙᵢₜᵢₐₗ: −0.10 V, E_{final}: +1.00 V, scan rate: 100 mV s−1).

FIG. 20 shows mean current observed (μA) at +0.59 V for the urine of a healthy female (test subject F1) for 3 consecutive months.

FIG. 21 shows mean current observed (μA) at +0.59V for the urine of a healthy female (test subject F1) for cycle 5 (blue) and cycle 6 (red).

FIG. 22 shows an ESS device with a three-electrode system in accordance with certain embodiments.

FIG. 23 shows mean current observed (μA) at +0.59 V for the urine of a healthy female (test subject F2) during the menstruation cycle.

FIG. 24 shows a two electrode prototype sensor for detecting the conductivity of sweat, in accordance with certain embodiments.

FIG. 25 shows a calibration plot (conductivity vs. total ion concentration) of a hydration sensor using artificial sweat (data points shown as blue diamonds). The orange square data point indicates the sweat conductivity of a normally hydrated individual.

FIG. 26 shows a calibration plot (conductivity vs. total ion concentration) of a hydration sensor using artificial sweat (data points shown as blue diamonds). The orange square data point indicates the sweat conductivity of a dehydrated individual.

FIG. 27 shows a calibration plot (conductivity vs. total ion concentration) of a hydration sensor using artificial sweat (data points shown as blue diamonds). The orange square data point indicates the sweat conductivity of an overhydrated individual.

FIG. 28A shows conductivity variation of the sweat of Test subject 01 from a normal condition to a dehydrated condition. FIG. 28B shows conductivity variation of the sweat of Test subject 02 from a normal condition to a dehydrated condition.

FIG. 29 shows a nonenyzmatic electrode sensor developed for the detection of glucose levels in saliva.

FIG. 30 shows a calibration plot (peak current vs. glucose concentration) for a glucose sensor in 0.1 M NaOH background.

FIG. 31 shows a graph (glucose level vs. days) of the variation of glucose levels in saliva samples collected for healthy Test subject 01.

FIG. 32 shows a graph (glucose level vs. days) of the variation of glucose levels in saliva samples collected for healthy Test subject 02.

### DETAILED DESCRIPTION

The terminology used in the description of the various described embodiments herein is for the purpose of describing particular embodiments only and is not intended to be limiting.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

Definitions

As used herein, the use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) and “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

The term “working electrode” or “WE” is used herein to refer to an electrode used to oxidize or reduce a targeted analyte. The working electrode produces a current when the target analyte is oxidized or reduced (at a given potential that depends on the target analyte in question). The working electrode is not particularly limited and may comprise any electrochemically inert, conductive material(s) in the voltage range used for analysis. In some embodiments, the working electrode may be mixed with an adhesive such as, without limitation, a conductive glue. The form of the working electrode is also not limited; for example, the working electrode may be in the form of wires, sheet, powder, or powder mixed with glue, fibers, thread and/or yarn. Non-limiting examples of working electrodes include carbon powder, silver powder, silver wire, and silver sheet.

As used herein, a “nonenzymatic modifier” refers to a nonenzymatic agent used to improve the selectivity and/or sensitivity of a working electrode for a particular target analyte. The nonenzymatic modifier is not particularly limited and any nonenzymatic agent that acts to increase selectivity and/or sensitivity of the working electrode for the target analyte may be used. For example, a nonenzymatic modifier may be any chemical that can increase the current produced by the working electrode when the target analyte is oxidized or reduced. The nonenzymatic modifier is generally applied to the surface of the working electrode, e.g., as a film or layer coating the surface of the working electrode. It may be applied, for example, by adsorption, bonding, coating, or as a composite (e.g., mixed with an electrode matrix material such as carbon particles to form a carbon paste containing the nonenzymatic modifier). In an embodiment, the nonenzymatic modifier is a surfactant. In one embodiment, the nonenzymatic modifier is Cetrimonium bromide (CTAB), or Cetylpyridinium bromide (CPB), or another quaternary ammonium surfactant. In an embodiment, the nonenzymatic modifier is Cetrimonium bromide (CTAB), e.g., 5 mmol dm⁻³ Cetrimonium bromide (CTAB). In another embodiment, the nonenzymatic modifier is Cetylpyridinium bromide (CPB), e.g., 5 mmol dm⁻³ Cetylpyridinium bromide (CPB).

The term “reference electrode” or “RE” is used herein to refer to electrodes used as the reference point to apply an electric potential. A reference electrode is generally an electrode which has a stable and well-known electrode potential and allows measurement of the potential of the working electrode without current passing through it. In some embodiments, reference and/or pseudo-reference electrodes are used. The reference electrode is not particularly limited and may comprise any electrochemically inert, conductive material(s) in the voltage range used for analysis. In some embodiments, the reference electrode may be mixed with an adhesive such as, without limitation, a conductive glue. For example, a reference electrode may comprise a stable metal and salt mixture mixed with a conductive glue. The form of the reference electrode is also not limited; for example, the reference electrode may be in the form of wires, sheet, powder, or powder mixed with glue, fibers, thread and/or yarn. Non-limiting examples of reference electrodes include silver wires, stainless steel, silver, silver chloride, and silver/silver chloride mixtures. In some embodiments, the reference electrode is a “pseudo-reference electrode”, such as an Ag wire, Ag ink, or Ag fabric, that fulfills the role of the reference electrode.

The term “counter electrode” or “CE” (also referred to as “auxiliary electrode”) is used herein to refer to electrodes used in the sensor system that complete the current path for the current produced by the working electrode. The counter electrode is not particularly limited and may comprise any electrochemically inert, conductive material(s) in the voltage range used for analysis. In some embodiments, the counter electrode may be mixed with an adhesive such as, without limitation, a conductive glue. The form of the counter electrode is also not limited; for example, the counter electrode may be in the form of wires, sheet, powder, or powder mixed with glue, fibers, thread and/or yarn. Non-limiting examples of counter or auxiliary electrodes include carbon powder, silver powder, silver wire, and silver sheet.

Electrodes used herein may be fabricated using conventional methods, and the method of fabrication is not particularly limited. For example, electrodes may be hand painted, printed, pasted, stamped, stitched, knitted, or woven on a substrate.

The terms “fourth electrode” or “FE” are used herein to refer to electrodes used for electrochemical generation of reagents and/or conditions required for the electrochemical reaction of an analyte, and/or for measuring the conductivity of the sample. As one non-limiting example, for an analysis requiring basic conditions, the fourth electrode can be used to generate hydroxyl ions (OH⁻) via an electrochemical reaction, to generate the required basic conditions. The fourth electrode is not particularly limited and may comprise any electrochemically inert, conductive material(s) in the voltage range used for analysis. In some embodiments, the fourth electrode may be mixed with an adhesive such as, without limitation, a conductive glue. The form of the fourth electrode is also not limited; for example, the fourth electrode may be in the form of wires, sheet, powder, or powder mixed with glue, or in the form of fibers, thread and/or yarn. Non-limiting examples of fourth electrodes include carbon powder, silver powder, silver wire, silver sheet, stainless steel wire, and stainless steel sheet. In some embodiments, the fourth electrode is another WE.

The term “analyte” is used herein to refer to any target redox-active compound in a sample which the ESS is used to detect or measure. For example, an analyte may be any redox-active chemical for which detection or measurement in a fluid or liquid is desired. Non-limiting examples of analytes include biomarkers, hormones, metabolites, glucose, proteins, peptides, nucleic acids, alcohol, electrolytes, ions, pH, and low molecular weight chemical compounds. In one embodiment, the analyte is a biological molecule. In an embodiment, the analyte is a hormone. In one embodiment, the analyte is estrogen, progesterone, a synthetic estrogen such as ethinylestradiol, and/or a synthetic progestin such as levonorgestrel. In another embodiment, the analyte is glucose. In another embodiment, the analyte is cortisol. In another embodiment, the analyte is uric acid. In further embodiments, the analyte is one or more salt or ion, e.g., associated with the hydration level of a subject.

The term “sample” is used herein to refer to any fluid or liquid in which it is desired to detect or measure a target analyte. In some embodiments, a sample is a biological fluid, e.g., a bodily fluid, such as without limitation urine, sweat or perspiration, saliva, tears, blood, semen, and/or interstitial fluid. In other embodiments, a sample is a beverage, a drinkable liquid, water, a culture media, or a liquid media. The sample is not meant to be particularly limited, and it should be understood that any fluid or liquid potentially containing a target analyte of interest is meant to be encompassed.

The term “substrate” is used herein to refer to a surface on which an electrochemical sensor system is disposed. Many different substrates may be used, and the substrate is not particularly limited. In some embodiments, the substrate is flexible and/or stretchable. In some embodiments, the substrate is wearable. Non-limiting examples of substrates include fabric, fiber, thread, yarn, paper, plastic, silicone, polyurethane, and the like. In particular embodiments, a substrate is a fabric. A fabric may be, for example, wool, cotton, synthetic (nylon, polyester, rayon, etc.). In some embodiments, the substrate is cotton, e.g., about 60%, about 70%, about 80%, about 85%, about 90%, about 95%, or 100% cotton. In some embodiments, the substrate is a yarn or a thread or a fiber. In some embodiments, the substrate is water-proof, e.g., Gore-Tex, neoprene, and the like. In some embodiments, the substrate is a plastic, e.g., polyethylene naphthalate (PEN), polyethylene terephthalate (PET), polytetrafluoroethylene (Teflon), Mylar, Kevlar, polyimide (Kapton), and the like. In some embodiments, the substrate is a cotton fabric coated with a hydrophobic substance such as a varnish or thermoplastic polyurethane (TPU). In some embodiments, the substrate is non-flexible and/or hard.

As used herein, the term “nonenyzmatic electrode system” or “NES” refers to an electrochemical sensor comprising at least one working electrode (WE); at least one counter electrode (CE); and a reference electrode (RE). The WE is electrochemically inert and conductive in a desired voltage range, the WE being configured to oxidize or reduce a target analyte and thereby produce a current. The WE also comprises a nonenzymatic modifier selected to increase sensitivity and/or selectivity of the WE for the target analyte. The CE and the RE are also electrochemically inert and conductive in the desired voltage range, the CE being configured to complete a current path for the current produced by the WE, and the RE being configured for use as a reference point. Typically, the current is measured between the working and counter electrodes, at a constant potential applied between the working and reference electrodes (i.e., an amperometry system). The current produced by the nonenyzmatic electrode system is proportional to the amount of the target analyte in the sample.

As used herein, the term “four electrode system” or “FES” refers to a nonenyzmatic electrode system that further comprises a “fourth electrode” (FE) used for electrochemical generation of reagents, conditions required for the electrochemical reaction of the target analyte, and/or for measurement of conductivity of the sample, and/or for optimization of conditions for oxidation or reduction of the target analyte.

As used herein, the term “reusable” refers to the capability of using the ESS to detect or measure more than one analyte. The ESS can be used to measure one analyte and then used subsequently to measure a second analyte simply by changing the electric potential and/or by changing the nonenzymatic modifier used with the ESS. In this way one ESS can be reused many times to detect or measure many different analytes, without requiring production of an entirely new sensor system or device for each analyte. The ESS can thus be easily and rapidly switched between applications simply by changing the electric potential or the nonenzymatic modifier.

As used herein, reference to “automatic” collection of samples or data, or samples or data “capable of being collected automatically,” refers to automatic collection of data from a sample by the ESS, e.g., without requiring active or ongoing preparation or participation by a subject or isolation of the sample from the subject. For example, in some embodiments data is collected automatically by a wearable sensor, without a requirement to first isolate the sample from the subject or other active participation by the subject wearing the sensor. In some embodiments, such automatic collection of the data, without requiring the subject's preparation or active participation to collect the data, is referred to as “wear-and-forget” use, as the subject wearing the sensor need take no further action other than putting the sensor on. In some embodiments, such automatic collection of the data is referred to as involuntary sample collection, the sample being analyzed automatically by the ESS without active participation by the subject or user.

### Structure of Sensor Systems and Other Electrochemical Devices

Electrochemical sensor systems (ESS) provided herein generally comprise one or more working electrode, a reference electrode, and one or more counter electrode. Many architectures or arrangements of the electrodes are possible in the ESS provided herein. For example, an ESS may comprise a nonenyzmatic electrode system (NES) comprising three or more electrodes, and may or may not comprise an FE. An ESS may comprise more than one type of working electrode that can be used to target more than one analyte, or multiple electrodes of the same type to increase the lifetime of the sensor. Multiple electrodes can be fabricated on the same substrate (single layer, or 2D architecture) or on multiple substrates (multiple layer, or 3D architecture). It should be understood that ESS and other electrochemical devices provided herein may be structured and constructed as known in the art. Several ESS are described here by way of example only, and these examples should not be taken as limiting in any way the structures or methods of fabrication of ESS, devices, or articles of manufacture thereof.

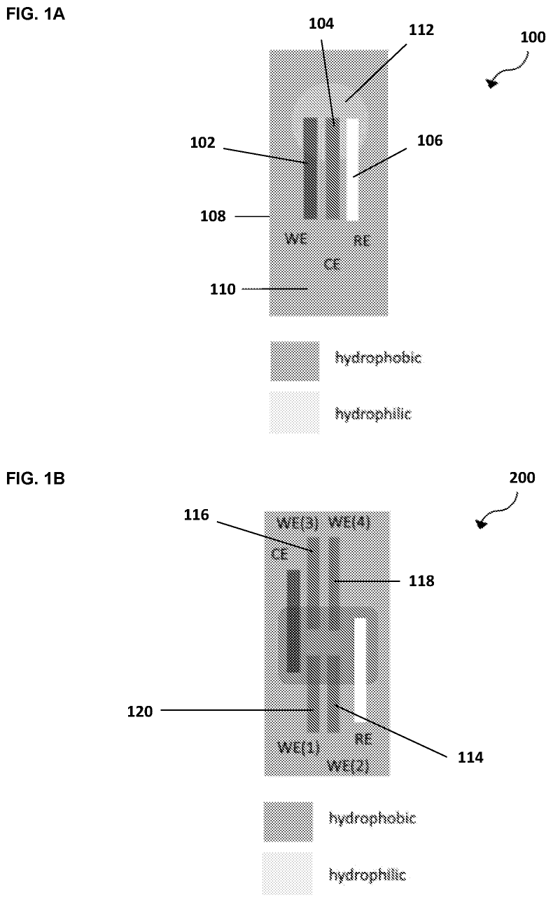

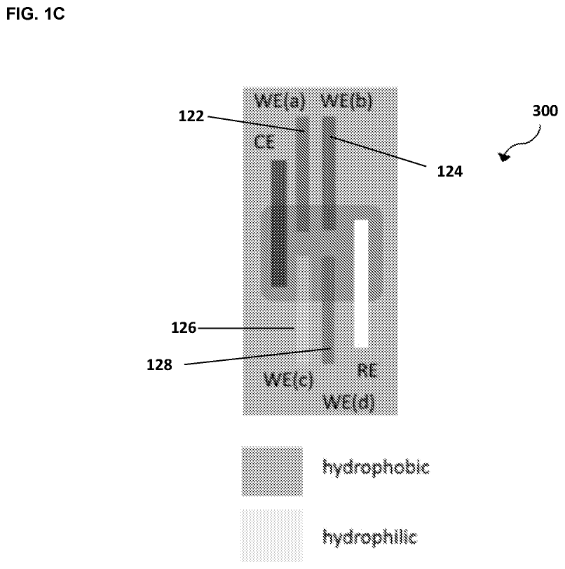

Referring to FIG. 1A, in accordance with one embodiment of the present technology, the ESS 100 has a nonenyzmatic electrode system having a single-layer architecture (a 2D setup). The ESS 100 comprises working electrode (WE) 102; a first counter electrode (CE) 104; and a reference electrode (RE) 106, each of which is electrically connected to a substrate 108. The substrate 108 has a hydrophobic region 110 and a hydrophilic region 112.

It should be understood that the arrangement of the WE 102, the CE 104, and the RE 106 is not particularly limited, and any suitable arrangement of electrodes can be used. Further, the sizes and shapes of the ESS 100 and/or the electrodes (WE 102, the CE 104, and the RE 106) are not particularly limited; any size or shape that produces a measurable current can be used herein. The number of working electrodes is also not limited, as multiple working electrodes can be used together in order to detect and/or monitor more than one analyte simultaneously. The sensor system can also be disposed upon one or more substrate layers, and may be provided in numerous configurations on the substrate layers.

Referring to FIG. 1B, in accordance with one embodiment, the ESS 200 is a nonenyzmatic electrode system having a single-layer architecture (a 2D setup). The ESS 200 includes four working electrodes disposed on the substrate 108: the first working electrode (WE(1)) 120, a second working electrode (WE(2)) 114, a third working electrode (WE(3)) 116, and a fourth working electrode (WE(4)) 118. In the embodiment shown in FIG. 1B, WE(1) 120, WE(2) 114, WE(3) 116, and WE(4) 118 are all electrodes of the same type. Use of more than one electrode of the same type can be used to improve the lifetime of a ESS. For example, WE(1) 120 can be used for a specified period of time, after which the sensor uses WE(2) 114 for a specified period of time, followed by use of WE(3) 116 for a specified period of time, etc. Thus each working electrode is used for a specified period of time (e.g., until the electrode stops responding), after which the system switches to use of another working electrode, thereby extending the lifetime of the sensor.

Referring to FIG. 1C, in accordance with one embodiment, the ESS 300 is a nonenyzmatic electrode system having a single-layer architecture (a 2D setup) and includes four working electrodes disposed on the substrate 108: a fifth working electrode (WE(a)) 122, a sixth working electrode (WE(b)) 124, a seventh working electrode (WE(c)) 126, and an eighth working electrode (WE(d)) 128. In the embodiment shown in FIG. 1C, WE(a) 122, WE(b) 124, WE(c) 126 and WE(d) 128 are all different types of electrodes, i.e., each electrode targets a different analyte. Thus multiple different types of working electrodes can be used in one ESS sensor to target multiple analytes.

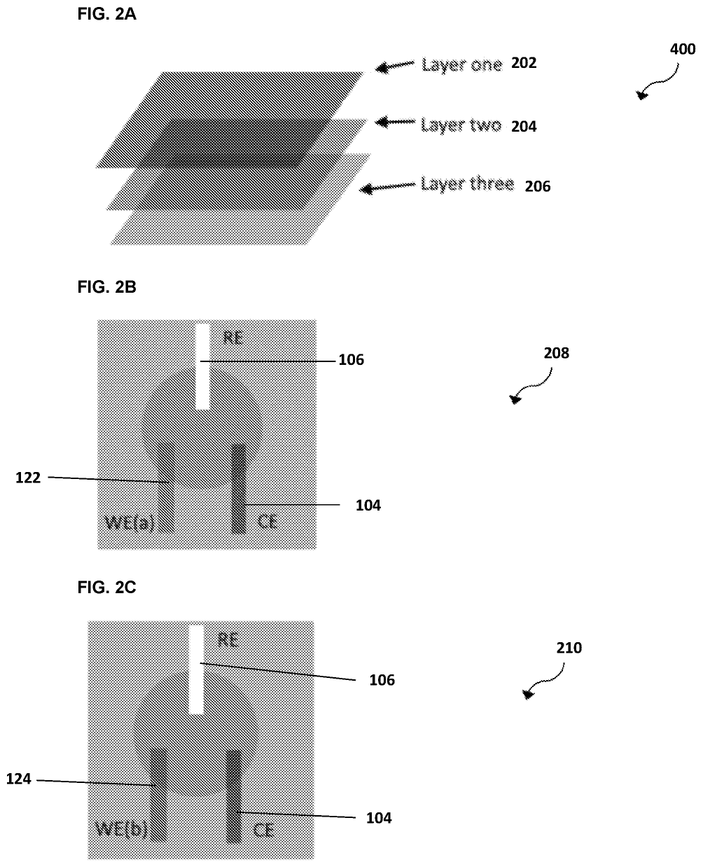

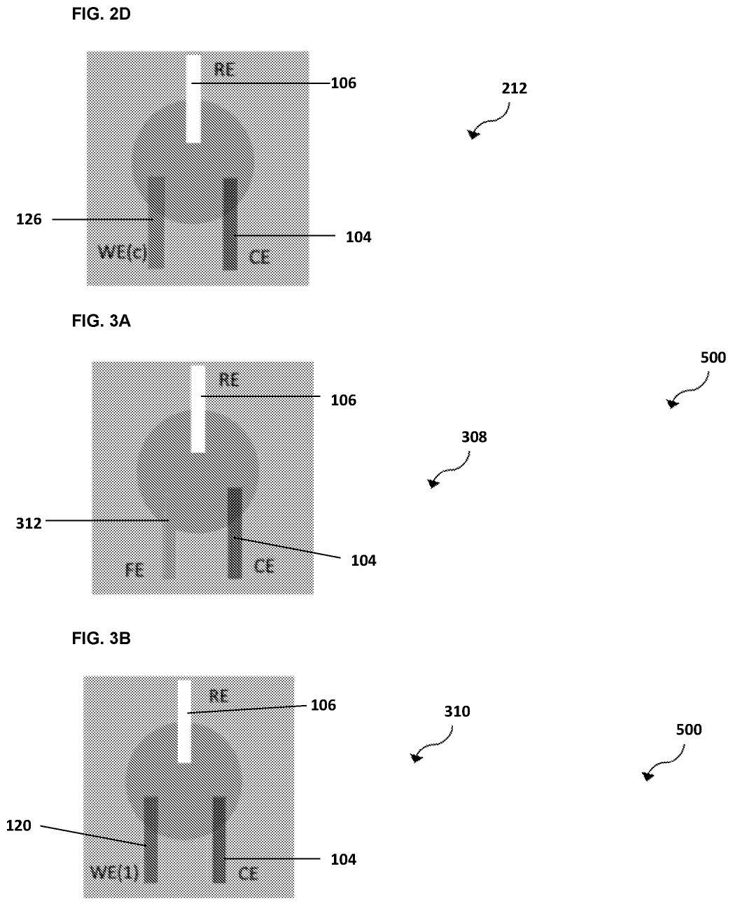

Referring to FIG. 2A, in accordance with one embodiment, the ESS 400 has a multiple-layer architecture (a 3D setup). The ESS 400 is a three-layer 3D sensor comprising a first layer 202 (Top layer, or Layer one), a second layer 204 (Middle layer, or Layer two), and a third layer 206 (Bottom layer, or Layer three). FIGS. 2B-2D show embodiments of the top layer 208, middle layer 210, and bottom layer 212 respectively of the ESS 400. The top layer 208 comprises WE(a) 122, first counter electrode (CE) 104, and reference electrode (RE) 106; the middle layer 210 comprises WE(b) 124, first counter electrode (CE) 104, and reference electrode (RE) 106; and the bottom layer 212 comprises WE(c) 126, first counter electrode (CE) 104, and reference electrode (RE) 106. As WE(a) 122, WE(b) 124, and WE(c) 126 are three different types of working electrodes, the top layer 208, middle layer 210, and bottom layer 212 can detect three analytes simultaneously.

FIGS. 3A-3B show the top layer 308 and the bottom layer 310 respectively of a two-layer 3D ESS 500, in accordance with one embodiment. The SS500 is a four electrode system. The top layer 308 comprises a fourth electrode (FE) 312, first counter electrode (CE) 104, and reference electrode (RE) 106. The bottom layer 310 comprises WE(1) 120, first counter electrode (CE) 104, and reference electrode (RE) 106. The top layer 308 can produce the required conditions/reagents electrochemically, and when a sample is introduced on to the top layer 308 it travels to the bottom layer 310 with the reagents; analysis is then performed on the bottom layer 310 (not depicted).

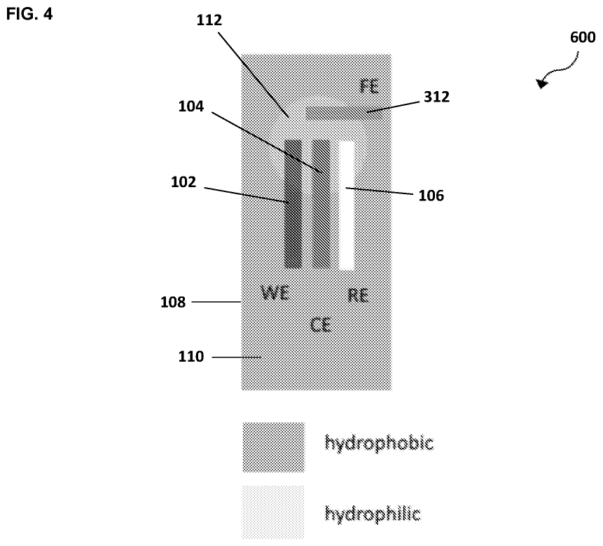

Referring to FIG. 4, in accordance with one embodiment, ESS 600 is a nonenyzmatic electrode system having a single-layer architecture (a 2D setup) and further comprising a fourth electrode. The ESS 600 comprises working electrode (WE) 102; first counter electrode (CE) 104; reference electrode (RE) 106; and fourth electrode (FE) 312, each of which is electrically connected to substrate 108. The substrate 108 has hydrophobic region 110 and hydrophilic region 112.

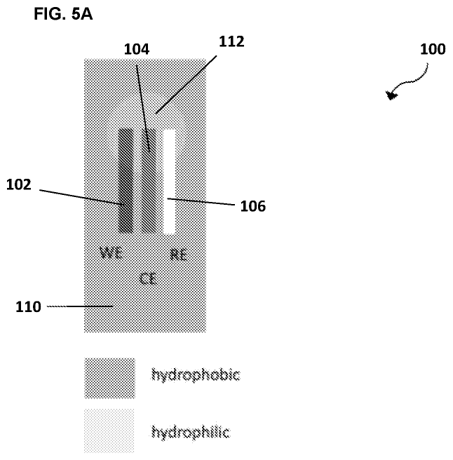

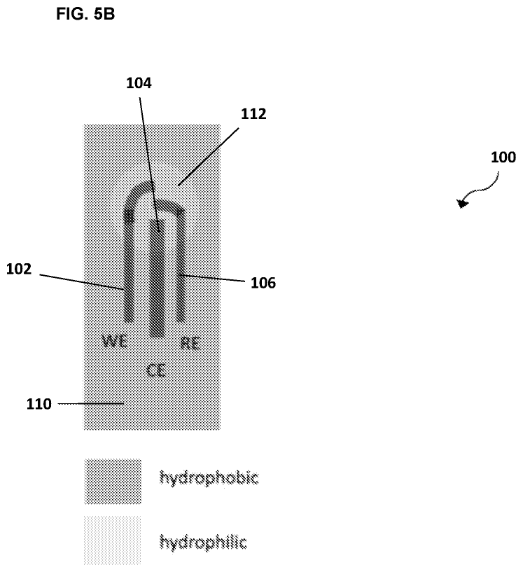

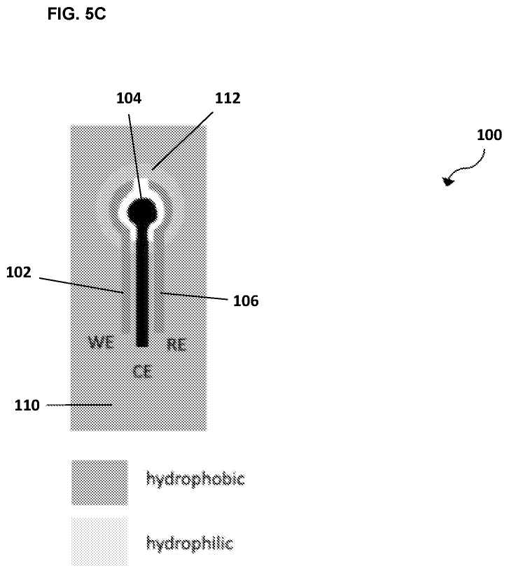

It should be understood that for electrodes used in ESS, many different shapes are possible. For example, electrodes may be rod-shaped (embodiment of ESS 100 shown in FIG. 5A), curved (embodiment of ESS 100 shown in FIG. 5B), or circular (embodiment of ESS 100 shown in FIG. 5C). The shape is not particularly limited and any appropriate shape may be used to fabricate the electrodes of the ESS.

In all embodiments, a nonenzymatic modifier agent such as a surfactant can optionally be used to improve the selectivity and/or sensitivity of a working electrode. In one embodiment, the nonenzymatic modifier is Cetrimonium bromide (CTAB), or Cetylpyridinium bromide (CPB), or another quaternary ammonium surfactant.

Furthermore, the structure of the ESSs of the present technology is not particularly limited and the number, size and configuration of substrate layers and electrodes disposed thereon may vary, depending on many factors such as the particular application, target analyte, sample, required properties, and the like.

As the electrochemical sensor systems (ESSs) may be implemented in a wide variety of designs, with a range of electrodes and materials, and in a broad range of applications, it should be understood that fabrication processes used with the present technology may vary greatly. ESS may be fabricated using any conventional method known in the art and, for example, using methods described hereinbelow in the Examples. In some embodiments, an ESS provided herein is hand painted, printed (e.g., screen printed), stamped, pasted or stitched onto a substrate. In some embodiments, the ESS is knitted or woven onto a yarn, thread, or fabric substrate; in some such embodiments, the ESS is subsequently added to (e.g., sewn into, embedded in) a garment or other wearable article.

Electrochemical sensor devices and fabrication thereof have been described (see, e.g., International Patent Application Publication No. WO2016/090189; International Patent Application Publication No. WO2017/058806; U.S. Pat. No. 6,952,604; U.S. Pat. No. 9,918,702; U.S. Pat. No. 9,895,273; U.S. Patent Application Publication No. 2018/0059051; International Patent Application Publication No. WO2018/071895; Zeng, W. et al., Advanced Material 2014, 26: 5310-5336; and Windmiller, J. R. and Wang, J., Electroanalysis 2013, 25(1): 29-46, each of which is incorporated by reference herein in its entirety). Additional information regarding the construction of ESSs, their design considerations, and the materials and components that may be employed therein is known in the art.

### Applications, Articles of Manufacture and Methods of Use

Electrochemical sensor systems (ESS) find use in a wide range of applications including, without limitation, healthcare, fitness monitoring, athletic performance, monitoring, military, security, industrial, and environmental monitoring applications. For example, ESS may be used to track exertion levels in a user for fitness, athletics, sport, or other performance monitoring; to monitor levels of a drug metabolite, a hormone, or glucose in a subject; to monitor environmental contamination of water supplies; to test chemical analyte levels (such as sugar, alcohol, sweetener, contaminants, etc.) in beverages; to test chemical analyte levels in water or aqueous samples; for environmental testing; and so on. It should be understood that the ESS may be used for any application where detection or monitoring of a target chemical analyte in a liquid sample is desired.

Accordingly a wide variety of articles may be produced incorporating electrochemical sensor systems (ESS) described herein. Non-limiting examples of devices or articles which may be made incorporating ESS described herein include, without limitation, medical devices; sports wear; athletic performance monitors; fitness monitors; personal electronic devices; environmental monitoring devices; beverage testing devices; medical diagnostic devices; wearable sensor devices; glucose monitors; and other health care products. In some embodiments, an ESS may be used for detection and/or quantitation of one or more analyte in a sample of water, e.g., drinking water, e.g., to monitor safety, contamination, portability, etc. of the water. In other embodiments, an ESS may be used for detection and/or quantitation of one or more analyte in a sample of a liquid industrial product, e.g., to monitor quality control of the product.

In some embodiments, an ESS described herein may be used in a wearable item. As used herein, “wearable” refers to an item which can be worn or placed on a body or body part. For example, a wearable may be an article of apparel, such as without limitation a garment. As used herein, the term “garment” refers to an article of apparel configured to be worn or placed on at least one body part of a subject, such as without limitation an undergarment, a flexible compression garment, a compression sleeve, a compression sock, a compression band, protective gear, sports apparel, military gear, military garments, biomedical and antimicrobial textiles, etc. A wearable may also be an electronically controlled or operated device such as a sensing device, a fitness monitor, and the like.

In one embodiment, an ESS described herein is implemented in a garment.

In some embodiments, an ESS described herein can be contained in a housing that electrically connects to the ESS via electrical contact pads on the substrate of the ESS that are interconnected to electrodes on the housing. In such embodiments, for example, the housed electronic system can be a portable device that attaches and detaches from the ESS, and can be stored on a user to be readily available for the user's next test, e.g., such as in a user's pocket, purse, etc. The ESS can make electrical contact with the portable device via a number of connections including pressure contacts, magnetic contacts, soldering contacts, etc. The housed electronic system can be in wired or wireless connection with a user's mobile communication or computing device, e.g., such as a smartphone, tablet, wearable computing device such as smartglasses, smartwatch, etc., and/or laptop or desktop computer. The housed electronic system can supply power, operate, and retrieve the acquired analyte-related electrical signals from the ESS. In such embodiments, the housed electronic system can comprise a data processing unit and an external display device configured to be in data communication with the data processing unit, e.g., via an operating system, which can include a visual display device, an audio display device, etc., such as a smartphone, tablet, and/or wearable technology device, among others. Many such implementations are known and may be used with ESS provided herein.

In some embodiments, an ESS described herein can be implemented as a skinworn tattoo- or patch-based wearable electrochemical biosensor device for non-invasive analyte detection and monitoring.

In some embodiments, an ESS described herein can be implemented as a portable sensor system, e.g., in a mobile phone or smartphone, a tablet, a wearable technology device, a portable device, etc.

In some embodiments, an ESS described herein may be used in a medical device. As one example, an ESS may be used for detection and/or quantitation of one or more analyte in a human or animal body. In some cases, one or more analyte can be monitored continuously in a bodily fluid in order to monitor biological or physiological changes in a subject. Such monitoring can allow early detection of a need to seek medical attention, of response to medication, of side effects, and the like.

In one embodiment, an ESS described herein may be used first to make initial baseline measurements of one or more analytes in a subject, allowing subsequent monitoring and detection of any change in the one or more analytes in a subject. For example, there is provided a method comprising using the ESS for nonselective detection of total redox-active compounds at a selected potential in a bodily fluid of a subject, thereby establishing an initial baseline for the subject. This step is then followed by detection and/or measurement using the ESS at the selected potential to monitor any change in the redox-active compounds in the bodily fluid of the subject. Since the baseline is set up based on each individual's physiochemical conditions, the ESS can be configured for each subject, even under different medical conditions. In this way, the ESS is easily customized for each subject. Since the ESS is a nonselective sensor, it can be used to target any analyte of interest in any bodily fluid, and can be used on any substrate (e.g., fabric) to detect the analytes in the subject. Once the user-specific baseline has been established, the ESS is then used for regular (e.g., daily, weekly, monthly, etc., as appropriate) monitoring of the analyte(s). The collected signal is compared with the baseline, and any change is reported to the user and/or the user's physician or other relevant professional. Detection of a change in one or more redox-active compound may indicate that the subject should seek medical attention, undergo further testing, administer medication, modify a dosage of medication, and the like.

In some such embodiments, the ESS is used for nonselective, nonspecific detection and/or measurement of one or more redox-active compound in a subject, the data being customized to the subject's baseline, such that changes in the one or more redox-active compound in the subject are easily and regularly monitored. Changes may be monitored continuously or on a regular basis, such as hourly, several times a day, daily, weekly, monthly, etc. In this way the system allows any change in physicochemical activities of the subject to be monitored. Since the monitoring process is based on comparing data to baseline data collected from the same subject, any individual under medical care or at risk of, or suffering from, a medical condition, can use the system to monitor physicochemical and physiological changes in their body. Further, in some embodiments, the reusability and washability of the ESS allows for continued, repeated use over a significant period of time and continuous monitoring. The ESS can also allow collection of data from multiple sources (multiple analytes, and/or multiple bodily fluids). In some embodiments, the ESS allows for cost-effective, fast, easy, and/or automatic collection of the data, without requiring the subject's preparation or active participation to collect the data, as in “wear-and-forget” use.

It should be understood that any article or device may comprise any one or more of the ESS described herein, in any configuration and combination.

In some embodiments, there are provided methods for monitoring, diagnosis or prognosis of a subject, the method comprising using the ESS to establish a baseline level of one or more analyte in a bodily fluid of the subject; measuring the level of the one or more analyte in the bodily fluid of the subject; comparing the level to the baseline level to determine whether the level has changed compared to the baseline level; and signaling or alerting the user when the level of the one or more analyte has changed compared to the baseline level. The methods may further comprise measuring the level of the one or more analyte repeatedly, at regular intervals, such as hourly, daily, twice-a-day, weekly, bi-weekly, monthly, etc. or continuously.

In one embodiment, there are provided electrochemical sensor systems and methods for the determination of hormones associated with the menstrual cycle in a bodily fluid of a subject. Such methods may be used, for example, for the detection and/or measurement of estrogen and/or progesterone, e.g., to detect ovulation, menstruation, menopause, pregnancy, and the like.

In an embodiment, there is provided a nonenzymatic electrochemical sensor system (ESS) for the detection and/or measurement of hormones associated with the menstrual cycle. In some such embodiments, the ESS is disposed on a fabric substrate, e.g., cotton, e.g., a thread, fiber, or yarn, e.g., a garment, e.g., an undergarment. In some such embodiments, the ESS comprises a laminating paper sensor or a wearable cotton sensor, such as described in the Examples hereinbelow. In some such embodiments, the ESS is used to detect variations in estrogen level associated with the menstrual cycle in urine from a subject. In some embodiments, the ESS is modified with a surfactant, e.g., CTAB, e.g., 5 mmol dm⁻³ CTAB. In one embodiment, the ESS comprises a nonenyzmatic electrode system comprising: a working electrode comprising 5 mmol dm⁻³ CTAB modified graphite-varnish 2:1 paste (w/w); a counter electrode comprising graphite-varnish 2:1 paste (w/w); and a reference electrode comprising a conductive Ag ink pseudo reference electrode. In another embodiment, the ESS comprises a nonenyzmatic electrode system comprising: a working electrode comprising 5 mmol dm⁻³ CTAB modified graphite-(polyurethane-crosslink 2:1) 4:2 paste (w/w); a counter electrode comprising graphite-(polyurethane-crosslink 2:1) 4:4 paste (w/w); and a reference electrode comprising an Ag fabric pseudo reference electrode. In some embodiments, estrogen is detected and/or measured by measuring the current response at +0.59 V.

Additional information regarding applications and implementations of ESSs is known in the art and can be found, for example, in International PCT Application Publication No. WO 2016/090189; International Patent Application Publication No. WO2017/058806; U.S. Pat. No. 6,952,604; U.S. Pat. No. 9,918,702; U.S. Pat. No. 9,895,273; U.S. Patent Application Publication No. 2018/0059051; International Patent Application Publication No. WO2018/071895; Zeng, W. et al., Advanced Material 2014, 26: 5310-5336; and Windmiller, J. R. and Wang, J., Electroanalysis 2013, 25(1): 29-46.

### EXAMPLES

The present invention will be more readily understood by referring to the following examples, which are provided to illustrate the invention and are not to be construed as limiting the scope thereof in any manner.

Unless defined otherwise or the context clearly dictates otherwise, all technical and scientific terms used herein have the same meaning as commonly understood by one of ordinary skill in the art to which this invention belongs. It should be understood that any methods and materials similar or equivalent to those described herein can be used in the practice or testing of the invention.

### Example 1. Laminating Paper Sensor

Laminating paper was used as the matrix for the fabrication of working, counter, and pseudo reference electrode materials. Graphite powder was used as the conductive material and commercially available varnish was used as the binder for preparation of carbon paste. Conductive Ag ink was used as the pseudo reference electrode. For the construction of a hydrophobic region on the cotton fabric sensor platform, commercially available varnish was coated on the fabric. This varnish-coated cotton fabric was used as the sensor platform and all electrodes were pasted on the cotton fabric sensor platform.

Nonenyzmatic electrode system consisted of: 5 mmol dm⁻³ CTAB modified graphite-varnish 2:1 paste (w/w) working electrode; graphite-varnish 2:1 paste (w/w) counter electrode; and conductive Ag ink pseudo reference electrode.

### Example 2. Wearable Cotton Sensor

Thermoplastic polyurethane (TPU) coated cotton fabric was used as the matrix for the fabrication of working and counter electrode materials. Conductive Ag fabric was used as the pseudo reference electrode. For the construction of a hydrophobic region on the cotton fabric sensor platform, thermoplastic polyurethane (TPU) was coated on fabric.

This TPU coated cotton fabric was also used as the sensor platform and all electrodes were pasted on the cotton fabric sensor platform. Graphite powder was used as the conductive material and (polyurethane-crosslink 2:1 w/w) was used as the binder for the preparation of carbon paste.

The nonenyzmatic electrode system consisted of: 5 mmol dm⁻³ CTAB modified graphite-(polyurethane-crosslink 2:1) 4:2 paste (w/w) working electrode; graphite-(polyurethane-crosslink 2:1) 4:4 paste (w/w) counter electrode; and Ag fabric pseudo reference electrode.

### Example 3. Sensor Validation

Validation of the electrochemical sensors, including the laminating paper sensor (Example 1) and the wearable cotton sensor (Example 2) was done using real samples under optimum Linear Sweep Voltammetry (LSV) conditions. Real sample analysis was done by monitoring the pattern of the variation of the current response at +0.59 V obtained due to the oxidation of estrogen at 5 mmol dm⁻³ CTAB modified working electrode. Based on the experimental results, the pattern of the variation of the current response at +0.59 V obtained for real samples at both sensors was similar to the pattern of the variation of the estrogen level in urine during the menstrual cycle. In addition, it was observed that, a lower current response before the end of the cycle indicated the low level of estrogen level in urine.

Further, it was found that both the laminating paper sensor and the wearable cotton sensor were stable to washing (both without detergents and with 0.1% detergents) and reusable.

This study indicates both 5 mmol dm⁻³ CTAB modified laminating paper sensor and wearable cotton sensor can be used to detect the variation of the estrogen level associated with the menstrual cycle in urine.

Example 4. Development of laminating paper sensor.

Laminating paper was placed on the stencils and the working and counter electrodes were fabricated using carbon paste and a pseudo reference electrode was fabricated using conductive Ag ink. The resistances of the working electrode and counter electrode were maintained less than 1.0 kΩ/cm.

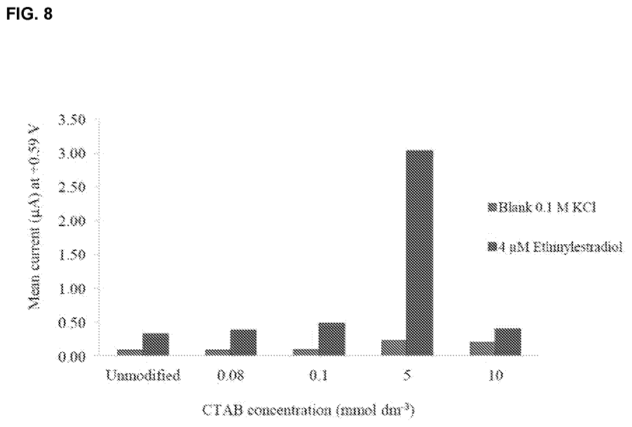

In the addition of CTAB solution, different concentrations of CTAB (0.08, 0.1, 5, and 10 mmol dm⁻³) were tested for ethinylestradiol (≈4 μmol dm⁻³) using Cyclic Voltammetry. The results are shown in Table 1 and FIG. 8.

TABLE 1
Mean current at +0.59 V obtained for blank (0.1 mol dm⁻³ KCl) and
oxidation of ethinylestradiol (≈4 μmol dm⁻³) at unmodified and CTAB
modified laminating paper sensors. (CV condition; Eᵢₙᵢₜᵢₐₗ: +0.10 V,
E_{middle}: +1.00 V, E_{final}: +0.10 V, scan rate: 100 mV s⁻³) (n = 3).

| Concentration | Mean current (μA) at +0.59 V | |
|---|---|---|
| of CTAB (mmol | Blank (0.1 mol | Ethinylestradiol (≈4 μmol |
| dm⁻³) | dm⁻³ KCl) | dm⁻³) |
| Unmodified | 0.09 (±0.01) | 0.32 (±0.04) |
| 0.08 | 0.09 (±0.01) | 0.38 (±0.04) |
| 0.1 | 0.10 (±0.01) | 0.49 (±0.05) |
| 5 | 0.23 (±0.01) | 3.03 (±0.05) |
| 10 | 0.20 (±0.01) | 0.40 (±0.01) |

According to the results, higher current responses (relative to the blank) were obtained for the oxidation of ethinylestradiol at the modified carbon paste working electrode containing different CTAB concentrations than for the oxidation of ethinylestradiol at the unmodified carbon paste working electrode. The current response increased with increasing concentration of CTAB. The highest current (relative to the blank) was obtained for 5 mmol dm⁻³ CTAB modified working electrode. This may be due to the change of the adsorptive behavior of CTAB with the increase in the concentration of CTAB, resulting in the increase of ethinylestradiol adsorbed to the electrode surface. When the concentration of CTAB was increased further, the current response was decreased. This may be caused by the micelle effect which could inhibit the electron transfer between ethinylestradiol and the electrode surface.

Therefore, 5 mmol dm⁻³ CTAB solution was selected as the suitable concentration for the preparation of CTAB modified carbon paste on laminating paper sensor.

### Example 5. Development of Wearable Cotton Sensor

5 mmol dm⁻³ CTAB modified graphite to (polyurethane-crosslink 2:1) binder 4:2 and 4:3 ratios were tested to optimize the suitable 5 mmol dm⁻³ CTAB modified graphite to (polyurethane-crosslink 2:1) binder ratio for the fabrication of modified working electrode material on TPU coated cotton fabric.

In the fabrication of working and counter electrode materials on TPU coated cotton fabric, the electrode materials were fabricated as a continuous and uniform film to obtain an approximately similar conductivity. Failure to make a continuous and uniform film may lead to high resistance thus leading to device failure. The resistances of both modified working electrodes constructed on TPU coated cotton fabric were less than 1.0 kΩ/cm. Moreover, unmodified working electrode material which is graphite to (polyurethane-crosslink 2:1) binder 4:3 w/w was also fabricated on TPU coated cotton fabric and the resistance was less than 1.0 kΩ/cm.

Graphite-(polyurethane-crosslink 2:1) binder 4:4 w/w paste was selected as the suitable electrode material to fabricate the counter electrode on TPU coated cotton fabric due to its low resistance (R<1.0 kΩ/cm) and also the texture of this paste is suitable for fabrication on fabric. Heat press (temperature 140° C. for 90 s) was applied after fabrication of both working and counter electrode materials on TPU coated cotton fabric to adhere the electrode materials to the matrix firmly. Conductive Ag fabric was used as the pseudo reference electrode. The width of the working, counter, and pseudo reference electrodes were 4 mm to maintain the conductivity at the required level.

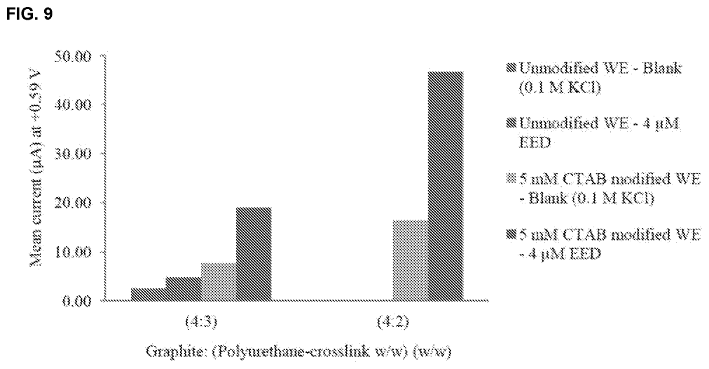

Both unmodified and CTAB modified working electrodes on wearable cotton sensor were validated using ethinylestradiol (≈4 μmol dm⁻³). Results are shown in Table 2 and FIG. 9.

TABLE 2
Mean current at +0.59 V obtained for blank (0.1 mol dm⁻³ KCl)
and ethinylestradiol (≈4 μmol dm⁻³) at unmodified
and 5 mmol dm⁻³ CTAB modified working electrodes on
wearable cotton sensor under optimum LSV conditions (n = 3).

| Graphite: | Mean current (μA) at +0.59 V | | | |
|---|---|---|---|---|
| polyurethane- | Unmodified WE | | CTAB modified wearable WE | |
| crosslink 2:1) | Blank | Ethinylestradiol | Blank | Ethinylestradiol |
| (w/w) ratio | (80 μl) | (80 μl) | (80 μl) | (80 μl) |

| | | | | | | | | |
|---|---|---|---|---|---|---|---|---|
| 4:3 | 2.57 | (±0.70) | 4.70 | (±0.86) | 7.76 | (±2.10) | 18.91 | (±1.43) |

| | | | | | | |
|---|---|---|---|---|---|---|
| 4:2 | — | — | 16.39 | (±3.29) | 46.76 | (±6.95) |

According to the results, the current responses at +0.59 V obtained for the oxidation of ethinylestradiol at 5 mmol dm⁻³ CTAB modified working electrodes were higher than the current response obtained at unmodified working electrode. Moreover, the highest current response (relative to blank) was obtained at 5 mmol dm⁻³ CTAB modified graphite-(polyurethane-crosslink 2:1 w/w) 4:2 (w/w) paste working electrode.

Therefore, 5 mmol dm⁻³ CTAB modified graphite to (polyurethane-crosslink 2:1 w/w) binder 4:2 (w/w) ratio was selected as the optimum ratio for the preparation of the modified working electrode material to fabricate on TPU coated cotton fabric of wearable cotton sensor for the analysis of real samples.

### Example 6. Analysis of Real Samples at Electrochemical Sensors

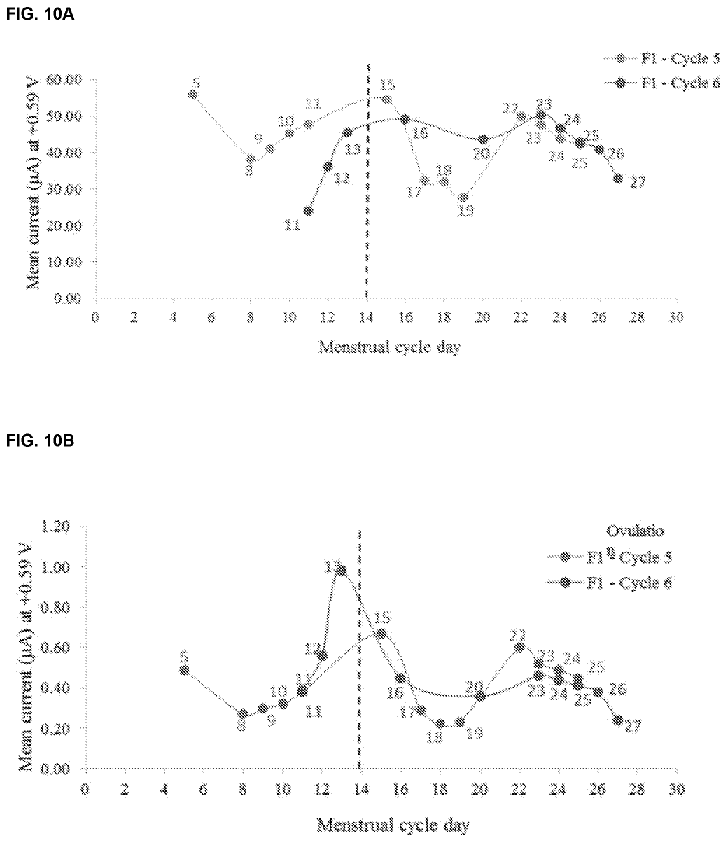

Real sample analysis. Characterization of the current response at wearable cotton sensor and laminating paper sensor was done using F1 samples. The results obtained for F1 samples at both types of electrochemical sensors are shown in Table 3 and FIGS. 10A-10B.

TABLE 3
Mean current at +0.59 V obtained for F1 samples
at wearable cotton sensor and laminating paper
sensor under optimum LSV conditions (n = 3).

| Menstrual | | | | | | | | |
|---|---|---|---|---|---|---|---|---|
| cycle | Mean current (μA) at +0.59 V | | | | | | | |
| day | Wearable cotton sensor | | | | Laminating paper sensor | | | |
| 1 | — | | — | | — | | — | |
| 2 | — | | — | | — | | — | |
| 3 | — | | — | | — | | — | |
| 4 | — | | — | | — | | — | |
| 5 | 55.96 | (±9.68) | — | | 0.49 | (±0.02) | — | |
| 6 | — | | — | | — | | — | |
| 7 | — | | — | | — | | — | |
| 8 | 38.22 | (±8.01) | — | | 0.27 | (±0.01) | — | |
| 9 | 41.13 | (±8.25) | — | | 0.30 | (±0.03) | — | |
| 10 | 45.28 | (±5.18) | — | | 0.32 | (±0.01) | — | |
| 11 | 47.96 | (±2.42) | 24.02 | (±4.48) | 0.38 | (±0.01) | 0.39 | (±0.06) |
| 12 | — | | 36.21 | (±5.18) | — | | 0.56 | (±0.08) |
| 13 | — | | 45.48 | (±3.82) | — | | 0.98 | (±0.04) |
| 14 | — | | — | | — | | — | |
| 15 | 54.61 | (±5.38) | — | | 0.67 | (±0.06) | — | |
| 16 | — | | 49.20 | (±2.84) | — | | 0.45 | (±0.03) |
| 17 | 32.37 | (±4.63) | — | | 0.29 | (±0.03) | — | |
| 18 | 32.11 | (±5.40) | — | | 0.22 | (±0.04) | — | |
| 19 | 27.80 | (±3.31) | — | | 0.23 | (±0.01) | — | |
| 20 | — | | 43.65 | (±2.35) | — | | 0.36 | (±0.03) |
| 21 | — | | — | | — | | — | |
| 22 | 49.83 | (±5.41) | — | | 0.60 | (±0.05) | — | |
| 23 | 47.54 | (±3.47) | 50.47 | (±3.89) | 0.52 | (±0.06) | 0.46 | (±0.01) |
| 24 | 43.84 | (±3.82) | 46.73 | (±1.80) | 0.49 | (±0.05) | 0.44 | (±0.02) |
| 25 | 42.23 | (±2.30) | 43.00 | (±1.60) | 0.45 | (±0.02) | 0.41 | (±0.02) |

| | | | | | | |
|---|---|---|---|---|---|---|
| 26 | — | 40.91 | (±2.17) | — | 0.38 | (±0.01) |
| 27 | — | 32.92 | (±3.85) | — | 0.24 | (±0.03) |

According to the results, obtained ovulation was identified using the increase in current response (day 13, FIGS. 10A-10B) detected due to the increase in estrogen level in urine. Menstruation was observed (day 27, FIGS. 10A-10B) when observed current was quite low which was followed by an increase in current (days 20, 21; FIGS. 10A-10B).

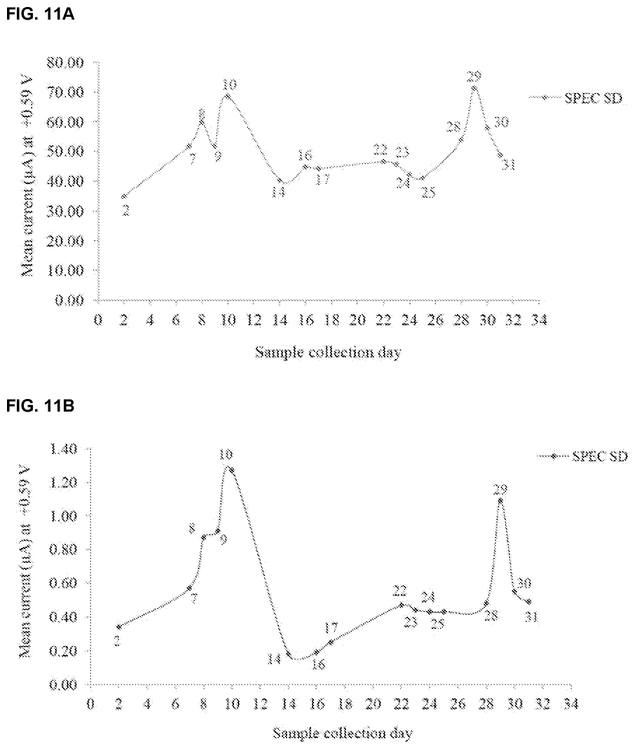

Real sample analysis using SPEC SD samples. Variation of the current response at +0.59 V obtained for SPEC SD samples was tested using a wearable cotton sensor and a laminating paper sensor. The results are shown in Table 4 and FIGS. 11A-11B.

TABLE 4
Mean current at +0.59 V obtained for SPEC SD samples
on laminating paper sensor and wearable cotton
sensor under optimum LSV conditions (n = 3).

| Sample | Sample | | | | |
|---|---|---|---|---|---|
| collection | collection | Mean current (μA) at +0.59 V | | | |
| date | day | Wearable cotton sensor | | Laminating paper sensor | |
| Oct. 31, 2017 | 1 | — | | — | |
| Nov. 1, 2017 | 2 | 34.88 | (±1.74) | 0.34 | (±0.02) |
| Nov. 2, 2017 | 3 | — | | — | |
| Nov. 3, 2017 | 4 | — | | — | |
| Nov. 4, 2017 | 5 | — | | — | |
| Nov. 5, 2017 | 6 | — | | — | |
| Nov. 6, 2017 | 7 | 51.79 | (±3.30) | 0.57 | (±0.01) |
| Nov. 7, 2017 | 8 | 59.88 | (±4.64) | 0.87 | (±0.02) |
| Nov. 8, 2017 | 9 | 51.92 | (±1.00) | 0.91 | (±0.04) |
| Nov. 9, 2017 | 10 | 68.58 | (±1.12) | 1.27 | (±0.24) |
| Nov. 10, 2017 | 11 | — | | — | |
| Nov. 11, 2017 | 12 | — | | — | |
| Nov. 12, 2017 | 13 | — | | — | |
| Nov. 13, 2017 | 14 | 40.27 | (±1.46) | 0.18 | (±0.02) |
| Nov. 14, 2017 | 15 | — | | — | |
| Nov. 15, 2017 | 16 | 44.85 | (±1.40) | 0.19 | (±0.01) |
| Nov. 16, 2017 | 17 | 44.21 | (±2.16) | 0.25 | (±0.02) |
| Nov. 17, 2017 | 18 | — | | — | |
| Nov. 18, 2017 | 19 | — | | — | |
| Nov. 19, 2017 | 20 | — | | — | |
| Nov. 20, 2017 | 21 | — | | — | |
| Nov. 21, 2017 | 22 | 46.57 | (±1.90) | 0.47 | (±0.03) |
| Nov. 22, 2017 | 23 | 45.72 | (±2.45) | 0.44 | (±0.01) |
| Nov. 23, 2017 | 24 | 42.19 | (±2.08) | 0.43 | (±0.02) |
| Nov. 24, 2017 | 25 | 41.00 | (±2.60) | 0.43 | (±0.01) |
| Nov. 25, 2017 | 26 | — | | — | |
| Nov. 26, 2017 | 27 | — | | — | |
| Nov. 27, 2017 | 28 | 53.92 | (±2.16) | 0.48 | (±0.03) |
| Nov. 28, 2017 | 29 | 71.35 | (±1.53) | 1.09 | (±0.07) |
| Nov. 29, 2017 | 30 | 57.97 | (±1.63) | 0.55 | (±0.01) |
| Nov. 30, 2017 | 31 | 48.74 | (±2.32) | 0.49 | (±0.02) |

According to the results, for SPEC SD (morning samples) on the wearable cotton sensor, from collection day 2 to day 8 the current response was increased, and slightly decreased on collection day 9. The highest current response was obtained on collection day 10. Current response was decreased on collection day 14 and slightly increased on collection day 16 and day 22. After collection day 22, the current response was slightly decreased. However, the current response remained low from collection day 14 to day 25. From collection day 28 to day 29, the current response was increased. On collection day 29, the highest current response was obtained. After collection day 29, the current response was decreased on collection day 30 and day 31.

For SPEC SD (morning samples) on the laminating paper sensor, from collection day 2 to day 10, the current response was increased. The highest current response was obtained on collection day 10. Current response was decreased on collection day 14 and slightly increased from day 16 to day 22. After day 22, the current response was gradually decreased. However, the current response remained low from day 14 to day 28. On collection day 29, the highest current response was obtained. After collection day 29, the current response was decreased on collection day 30 and day 31.

For SPEC SD, a new menstrual cycle started on collection day 14 (characterized by low current response). According to the results, a lower current response was obtained for SPEC SD on day 1 of the menstrual cycle. A higher current response obtained on collection day 29 was the day 16 of the menstrual cycle, which could be related to the peak observed in ovulation in the menstrual cycle.

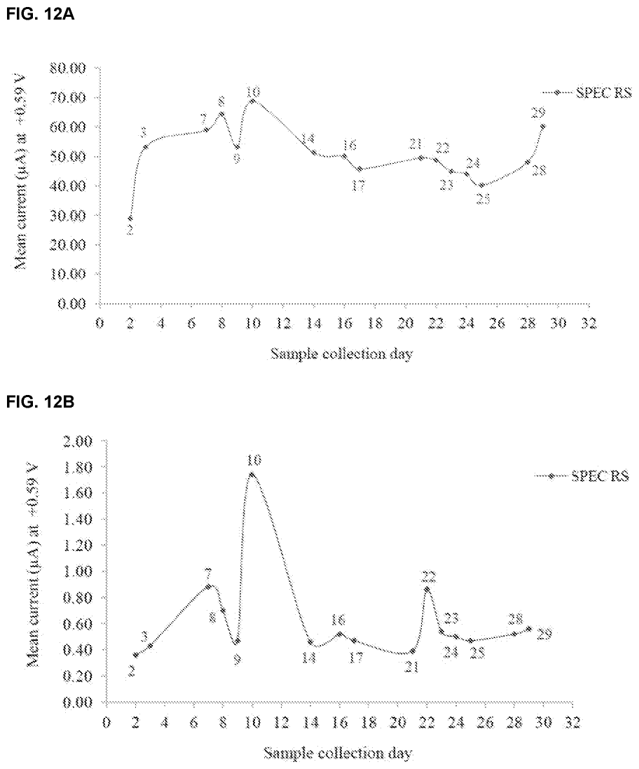

Real sample analysis using SPEC RS samples. Variation of the current response at +0.59 V obtained for SPEC RS samples were tested using a wearable cotton sensor and a laminating paper sensor. The results are shown in Table 5 and FIGS. 12A-12B.

TABLE 5
Mean current at +0.59 V obtained for SPEC RS samples
on wearable cotton sensor and laminating paper
sensor under optimum LSV conditions (n = 3).

| Sample | Sample | | |
|---|---|---|---|
| collection | collection | Mean current (μA) at +0.59 V | |
| date | day | Wearable cotton sensor | Laminating paper sensor |
| Oct. 31, 2017 | 1 | — | — |

| | | | | | |
|---|---|---|---|---|---|
| Nov. 1, 2017 | 2 | 28.92 | (±1.67) | 0.36 | (±0.01) |
| Nov. 2, 2017 | 3 | 53.17 | (±1.95) | 0.43 | (±0.01) |

| | | | |
|---|---|---|---|
| Nov. 3, 2017 | 4 | — | — |
| Nov. 4, 2017 | 5 | — | — |
| Nov. 5, 2017 | 6 | — | — |

| | | | | | |
|---|---|---|---|---|---|
| Nov. 6, 2017 | 7 | 58.95 | (±2.98) | 0.88 | (±0.03) |
| Nov. 7, 2017 | 8 | 64.34 | (±4.42) | 0.70 | (±0.02) |
| Nov. 8, 2017 | 9 | 53.10 | (±3.18) | 0.47 | (±0.02) |
| Nov. 9, 2017 | 10 | 68.71 | (±1.52) | 1.74 | (±0.57) |

| | | | |
|---|---|---|---|
| Nov. 10, 2017 | 11 | — | — |
| Nov. 11, 2017 | 12 | — | — |
| Nov. 12, 2017 | 13 | — | — |

| | | | | | |
|---|---|---|---|---|---|
| Nov. 13, 2017 | 14 | 51.31 | (±2.90) | 0.46 | (±0.02) |

| | | | |
|---|---|---|---|
| Nov. 14, 2017 | 15 | — | — |

| | | | | | |
|---|---|---|---|---|---|
| Nov. 15, 2017 | 16 | 50.04 | (±1.00) | 0.52 | (±0.02) |
| Nov. 16, 2017 | 17 | 45.73 | (±1.39) | 0.47 | (±0.03) |

| | | | |
|---|---|---|---|
| Nov. 17, 2017 | 18 | — | — |
| Nov. 18, 2017 | 19 | — | — |
| Nov. 19, 2017 | 20 | — | — |

| | | | | | |
|---|---|---|---|---|---|
| Nov. 20, 2017 | 21 | 49.45 | (±1.41) | 0.39 | (±0.02) |
| Nov. 21, 2017 | 22 | 48.66 | (±2.87) | 0.86 | (±0.05) |
| Nov. 22, 2017 | 23 | 44.87 | (±1.31) | 0.54 | (±0.04) |
| Nov. 23, 2017 | 24 | 44.04 | (±1.49) | 0.50 | (±0.03) |
| Nov. 24, 2017 | 25 | 40.17 | (±4.54) | 0.47 | (±0.01) |

| | | | |
|---|---|---|---|
| Nov. 25, 2017 | 26 | — | — |
| Nov. 26, 2017 | 27 | — | — |

| | | | | | |
|---|---|---|---|---|---|
| Nov. 27, 2017 | 28 | 48.01 | (±1.91) | 0.52 | (±0.02) |
| Nov. 29, 2017 | 29 | 60.12 | (±2.57) | 0.56 | (±0.02) |

| | | | |
|---|---|---|---|
| Nov. 29, 2017 | 30 | — | — |
| Nov. 30, 2017 | 31 | — | — |

For SPEC RS (morning samples) on the wearable cotton sensor, the current response was increased from collection day 2 to day 8. The current response obtained on collection day 9 was less than the current response obtained on collection day 8 and collection day 10. The highest current response was obtained on collection day 10. After collection day 10, the current response was gradually decreased from collection day 14 to day 25. After collection day 25, the current response was increased from collection day 28 and day 29.

For SPEC RS (morning samples) on the laminating paper sensor, the current response was increased from collection day 2 to day 7. The current response was decreased from collection day 8 to day 9 and the highest current response was obtained on collection day 10. After collection day 10, the current response was decreased and on collection day 22, the current response was slightly increased. The current response was gradually decreased from day 23 to day 25. The current response was slightly increased from collection day 28 and day 29.

For SPEC RS, a new menstrual cycle was started on collection day 24 (characterized by low current) which is the day 1 of the new cycle. According to the results, the current response gradually decreased before the end of the cycle (from collection day 21 to day 24). A higher current response was obtained on the collection day 10, which could be related to high current peak observed during ovulation.

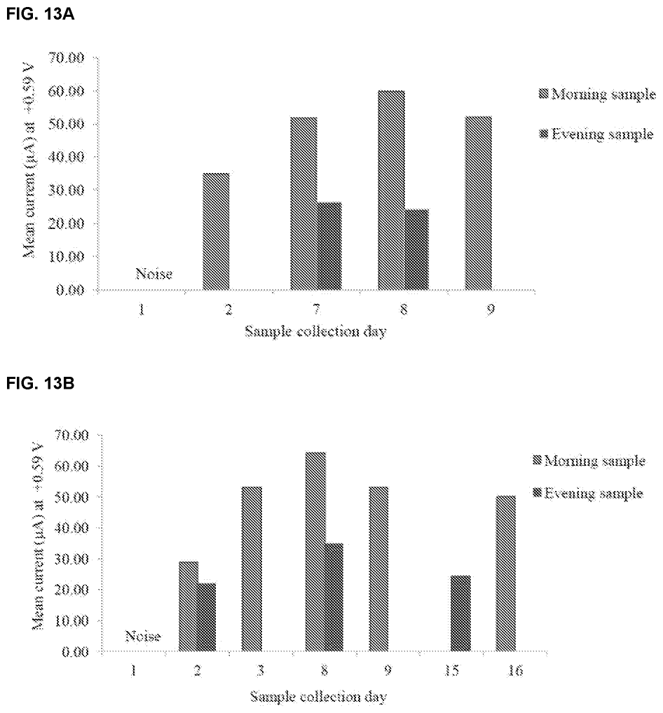

Comparison of the current response obtained for morning and evening samples of SPEC SD and SPEC RS on a wearable cotton sensor. The SPEC SD and SPEC RS samples collected in the evening were tested on the next day for the determination of the effect of the time for the current response. The results obtained for both samples are shown in Table 6 and Table 7, respectively and FIGS. 13A-13B.

TABLE 6
Mean current at +0.59 V obtained for SPEC SD
morning and evening samples on wearable cotton
sensor under optimum LSV conditions (n = 3).

| | | Mean current | | | |
|---|---|---|---|---|---|
| Sample | Sample | (μA) at +0.59 V | | | |
| collection | collection | Morning | | Evening | |
| date | day | sample | | sample | |
| Oct. 31, 2017 | 1 | — | | Noise | |
| Nov. 1, 2017 | 2 | 34.88 | (±1.74) | — | |
| Nov. 6, 2017 | 7 | 51.79 | (±3.30) | 26.42 | (±1.81) |
| Nov. 7, 2017 | 8 | 59.88 | (±4.64) | 24.13 | (±2.49) |

| | | | | |
|---|---|---|---|---|
| Nov. 8, 2017 | 9 | 51.92 | (±1.00) | — |

TABLE 7
Mean current at +0.59 V obtained for SPEC RS
morning and evening samples on wearable cotton
sensor under optimum LSV conditions (n = 3).

| | | Mean current (μA) | | | |
|---|---|---|---|---|---|
| Sample | Sample | at +0.59 V | | | |
| collection | collection | Morning | | Evening | |
| date | day | sample | | sample | |
| Oct. 31, 2017 | 1 | — | | Noise | |
| Nov. 1, 2017 | 2 | 28.95 | (±1.66) | 21.80 | (±4.40) |
| Nov. 2, 2017 | 3 | 53.20 | (±1.91) | — | |
| Nov. 7, 2017 | 8 | 64.34 | (±4.42) | 34.64 | (±3.16) |

| | | | | |
|---|---|---|---|---|
| Nov. 8, 2017 | 9 | 53.10 | (±3.18) | — |

| | | | | |
|---|---|---|---|---|
| Nov. 14, 2017 | 15 | — | 24.31 | (±2.81) |

| | | | | |
|---|---|---|---|---|
| Nov. 15, 2017 | 16 | 50.04 | (±1.00) | — |

Evening samples were tested 12 h after the sample collection time. According to the results, for both SPEC SD and SPEC RS, lower current responses were obtained for evening samples than the current responses obtained for morning samples collected in the same day and the next day. This may be due to the degradation of the estrogen with time.

### Example 7. Validation of the Electroanalytical Method Performed Using Wearable Cotton Sensor

Construction of calibration plot. To validate the electroanalytical method performed using the wearable cotton sensor and to evaluate the applicability of this developed sensor for the determination of ethinylestradiol/estrogen, the relationship between the oxidation current response at +0.59 V and the concentration of ethinylestradiol was investigated.

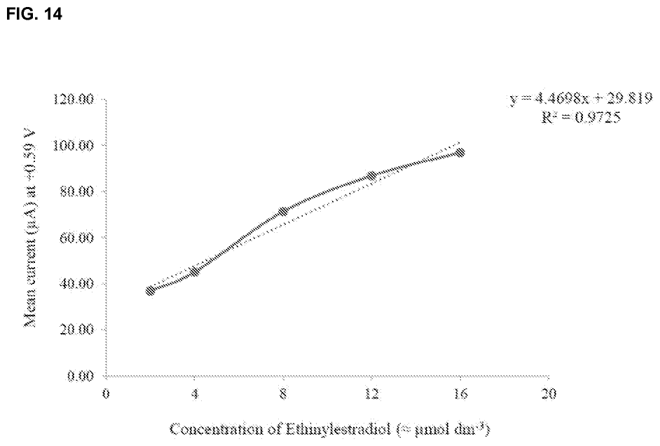

All the ethinylestradiol solutions were prepared using ethinylestradiol containing tablet extraction (one tablet contains 0.03 mg of ethinylestradiol). It is noted that the following assumption was made: the extraction efficiency of ethinylestradiol from each tablet is 100%. The concentration of the stock solution of ethinylestradiol is ≈20 μmol dm⁻³. The uncertainty associated with the concentration of ethinylestradiol solutions prepared using tablet extraction needs to be considered to ensure that it is fit for this purpose. Therefore, two series of ethinylestradiol solutions with the same concentration were prepared separately and each concentration from each series was tested on an electrochemical sensor using the same electroanalytical method. The results obtained for the concentration series of ethinylestradiol and the blank solution are shown in Table 8 and FIG. 14.

TABLE 8
Oxidation mean current response at
+0.59 V for different concentrations
of ethinylestradiol on a wearable
cotton sensor under optimum
LSV conditions (n = 4).

| | | Mean | |
|---|---|---|---|
| Extraction | | current | |
| efficiency | [Ethinylestradiol] | (μA) at | |
| (%) | (≈μmol dm⁻³) | +0.59 V | |
| Blank | — | 18.64 | (±1.12) |
| 1% | 0.2 | 21.17 | (±1.19) |
| 3% | 0.6 | 22.08 | (±1.12) |
| 5% | 1 | 30.98 | (±1.15) |
| 10% | 2 | 36.85 | (±2.23) |
| 20% | 4 | 45.02 | (±1.78) |
| 40% | 8 | 71.26 | (±3.72) |
| 60% | 12 | 86.81 | (±3.79) |
| 80% | 16 | 96.89 | (±1.99) |
| 100% | 20 | 102.11 | (±4.47) |

As shown in FIG. 14, ethinylestradiol oxidation current response at +0.59 V linearly increased with the concentration of ethinylestradiol in the range of ≈2 μmol dm⁻³ to ≈16 μmol dm⁻³. According to the results, the linear regression equation and the correlation coefficient were l (μA)=4.4698c (μmol dm⁻³)+29.819 and R²=0.9725, respectively.

Limit of detection (LoD) and Limit of Quantification (LoQ). LoD and LoQ parameters can be used to express the concentration of ethinylestradiol in the sample that can be confidently detected and reliably quantified with acceptable reliability and accuracy.

Due to the negative value concentration obtained for the current response at +0.59 V for the blank samples (0.1 mol dm⁻³ KCl) under optimum LSV conditions, blank samples were spiked with the lowest possible ethinylestradiol concentration which gives a measurable current at +0.59 V for positive concentration value. It was found that the lowest fortified ethinylestradiol concentration for blank sample was ≈1 μmol dm⁻³. Therefore, determination of LoD and LoQ were performed by spiking the blank solution (0.50 ml, 0.1 mol dm⁻³ KCl) with a known amount of ethinylestradiol solution (2.00 ml, ≈1 μmol dm⁻³). The results obtained for ten independent spiked samples are shown in Table 9.

TABLE 9
Ethinylestradiol oxidation current
responses at +0.59 V obtained for
the determination of LoD and LoQ
on the wearable cotton sensor under
optimum LSV conditions (n = 4).

| | Mean | |
|---|---|---|
| | current | |
| | (μA) at | [Ethinylestradiol] |
| Sample | +0.59 V | (≈μmol dm⁻³) |
| 1 | 31.32 | 0.34 |
| 2 | 30.32 | 0.11 |
| 3 | 31.09 | 0.28 |
| 4 | 31.52 | 0.38 |
| 5 | 32.27 | 0.55 |
| 6 | 30.84 | 0.23 |
| 7 | 31.18 | 0.30 |
| 8 | 30.75 | 0.21 |
| 9 | 31.37 | 0.35 |
| 10 | 32.36 | 0.57 |

According to the calculations, LoD and LoQ were ≈0.76 μmol dm⁻³ and ≈1.76 μu mol dm⁻³, respectively. Therefore, the concentration of ethinylestradiol in the sample that could be confidently detected was ≈0.76 μmol dm⁻³ and the concentration of ethinylestradiol in the sample that could be reliably quantified with acceptable reliability and accuracy was ≈1.76 μmol dm⁻³ under optimum LSV conditions on the wearable cotton sensor.

Sensitivity. The sensitivity of the electroanalytical method performed using the developed electrochemical sensor was determined, because it is a measurement of the capability of the analytical method to discriminate a small difference in the concentration of ethinylestradiol. Slope of the calibration plot represents the sensitivity. According to the results, the sensitivity of the electroanalytical method performed using the wearable cotton sensor was ≈4.4698 A mol⁻¹ dm³.

Precision and Repeatability. For statistical determination of the precision and repeatability of the method, ten repeated analyses were performed with ethinylestradiol solutions (≈4 μmol dm⁻³). Results are shown in Table 10.

TABLE 10
Oxidation current responses at +0.59 V
obtained for ≈4 μmol dm⁻³ ethinylestradiol
solutions on a wearable cotton sensor
under LSV optimum conditions.

| | Mean | |
|---|---|---|
| | current | |
| Test | (μA) at | [Ethinylestradiol] |
| number | +0.59 V | (≈μmol dm⁻³) |
| 1 | 46.20 | 3.66 |
| 2 | 43.73 | 3.11 |
| 3 | 45.91 | 3.60 |
| 4 | 46.77 | 3.79 |
| 5 | 44.19 | 3.22 |
| 6 | 45.43 | 3.49 |
| 7 | 42.92 | 2.93 |
| 8 | 47.35 | 3.92 |
| 9 | 46.28 | 3.68 |
| 10 | 43.84 | 3.14 |

According to the calculations, precision and repeatability of the electroanalytical method performed using the developed electrochemical sensor with 5 mmol dm⁻³ CTAB modified graphite-(polyurethane-crosslink 2:1) 4:2 paste working electrode (fabricated on TPU coated cotton fabric) were 9.65% and 0.93, respectively.

Results of linear range, LoD, LoQ, sensitivity, precision, and repeatability of the electroanalytical method performed using the wearable cotton sensor are summarized in Table 11.

TABLE 11
Linear range, LoD, LoQ,
sensitivity, precision,
and repeatability of the
electroanalytical method.

| | Wearable |
|---|---|
| | cotton |
| | sensor |
| Linear range (μmol dm⁻³) | ≈2-16 |
| LoD (μmol dm⁻³) | ≈0.76 |
| LoQ (μmol dm⁻³) | ≈1.76 |
| Sensitivity (A mol⁻¹ dm⁻³) | ≈4.4698 |
| Precision (RSD %) | 9.65 |
| Repeatability | 0.93 |

### Example 8. Washing Stability of Electrochemical Sensors

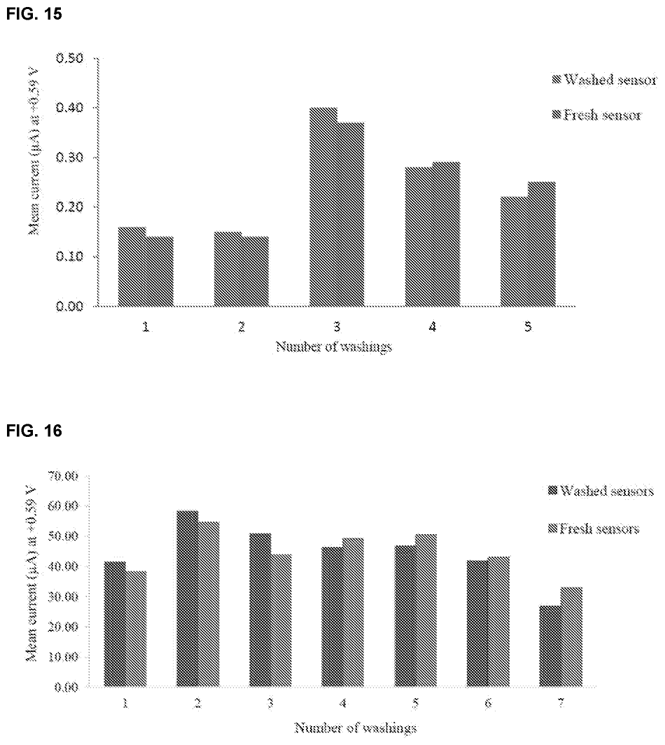

Washing stability of laminating paper sensor. Washing stability of laminating paper sensor with 0.1% detergents was tested using real samples (F1 samples). The mean current response at +0.59 V obtained for F1 samples at washed laminating paper sensors was compared with the mean current response at +0.59 V obtained for F1 samples at fresh laminating paper sensors after each washing cycle. The results are shown in Table 12 and FIG. 15.

TABLE 12
Mean current response at
+0.59 V obtained for F1 samples at
washed laminating paper sensors
with 0.1% detergents and fresh
laminating paper sensors under
optimum LSV conditions (n = 3).

| | Mean current (μA) | | | |
|---|---|---|---|---|
| | at +0.59 V | | | |
| | Washed | | Fresh | |
| | laminating | | laminating | |
| Number of | paper | | paper | |
| washings | sensors | | sensors | |
| After 1st wash | 0.16 | (±0.02) | 0.14 | (±0.04) |
| After 2nd wash | 0.15 | (±0.04) | 0.14 | (±0.03) |
| After 3rd wash | 0.40 | (±0.05) | 0.37 | (±0.06) |
| After 4th wash | 0.28 | (±0.06) | 0.29 | (±0.01) |
| After 5th wash | 0.22 | (±0.04) | 0.25 | (±0.02) |

According to the results, from the first washing cycle to the third washing cycle, the mean current response obtained at washed electrodes was slightly higher than the mean current response obtained at fresh electrodes. In the fourth and fifth washing cycles, the mean current response obtained at washed electrodes was slightly lower than the mean current response obtained at fresh electrodes. The percentage of the variation of the current responses obtained at the washed sensor were less than 15% compared to the current responses obtained at fresh electrodes after five washing cycles. According to the results, there was no significant difference between the current response obtained for both fresh and washed sensors after five washings. Therefore, CTAB modified electrode material is washing stable, and this developed sensor can be reused after washing with 0.1% detergents.

Washing stability of wearable cotton sensor. Washing stability of a wearable cotton sensor was tested with 0.1% detergents using real samples (F1 samples). The mean current response at +0.59 V obtained for F1 samples at washed sensors was compared with the mean current response at +0.59 V obtained for F1 sample at fresh sensors after each washing. The results are shown in Table 13 and FIG. 16.

TABLE 13
Mean current response at +0.59 V obtained
for F1 samples on wearable cotton sensor
under optimum LSV conditions (n = 3).

| | Mean current (μA) | | | |
|---|---|---|---|---|
| | at +0.59 V | | | |
| Number of | Washed | | Fresh | |
| washings | sensors | | sensors | |
| After 1st wash | 41.42 | (±4.51) | 38.22 | (±8.01) |
| After 2nd wash | 58.24 | (±7.66) | 54.61 | (±5.38) |
| After 3rd wash | 50.77 | (±3.68) | 43.84 | (±3.82) |
| After 4th wash | 46.27 | (±2.23) | 49.20 | (±2.84) |
| After 5th wash | 46.90 | (±1.88) | 50.43 | (±3.89) |
| After 6th wash | 41.78 | (±1.40) | 43.00 | (±1.60) |
| After 7th wash | 27.01 | (±2.01) | 32.92 | (±3.85) |

The current responses at +0.59 V obtained for F1 samples for washed sensors after each washing (with 0.1% detergents) were compared with the current responses obtained for fresh sensors. According to the results, from the first washing cycle to the third washing cycle, the mean current responses obtained at washed electrodes were slightly higher than the mean current responses obtained at fresh electrodes. From the fourth washing cycle to the seventh washing cycle, the mean current responses obtained at washed electrodes were slightly lower than the mean current responses obtained at fresh electrodes. Therefore, 5 mmol dm⁻³ CTAB modified graphite-(polyurethane-crosslink 2:1) 4:2 paste working electrode material, graphite-(polyurethane-crosslink 2:1) 4:4 paste counter electrode material and conductive Ag fabric are washing stable with 0.1% detergent and can be reused after washing with 0.1% detergents.

It is noted that the electrode surface was regenerated during washing due to the removal of retained compounds/deposits on the surface of the electrodes. According to the results, the electrochemical properties of all three electrodes may not be affected after washing with and without detergents.

However, the unmodified carbon paste and CTAB modified carbon paste prepared using commercially available varnish can be easily damaged/removed from the electrode fabricated matrix (laminating paper) during washing because of the dry texture of the pastes. CTAB modified working and counter electrode materials prepared using (polyurethane-crosslink 2:1) mixture as the binder when fabricated on TPU coated cotton fabric (wearable cotton sensor) were more stable during washing. This may be due to the adhesion of the electrode materials to the matrix firmly in the application of heat press after fabrication of working and counter electrode materials on TPU coated cotton fabric matrix.

Effect of detergents on wearable cotton sensor. The effect of the detergents on the wearable cotton sensor was studied. The results are shown in Table 14 and FIG. 17.

TABLE 14
Mean current at +0.59 V obtained
for different test solutions on
wearable cotton sensor under
optimum LSV conditions (n = 3).

| | Mean current | |
|---|---|---|
| | (μA) at | |
| Test solution | +0.59 V | |
| Blank (distilled water) | 14.98 | (±3.29) |
| 0.1% detergent in distilled water | 23.81 | (±1.38) |
| ≈4 μmol dm⁻³ Ethinylestradiol | 44.76 | (±2.99) |
| (at washed electrodes) | | |
| Blank (0.1 mol dm⁻³ KCl) | 19.00 | (±1.29) |
| 0.1% detergent in | 24.03 | (±4.01) |
| 0.1 mol dm⁻³ KCl | | |
| ≈4 μmol dm⁻³ Ethinylestradiol | 45.84 | (±1.63) |
| (at washed electrodes) | | |
| ≈4 μmol dm⁻³ Ethinylestradiol | 43.92 | (±3.08) |

(at fresh electrodes)

According to the results, the current responses at +0.59 V obtained for 0.1% detergent solutions were slightly higher than the current responses at +0.59 V obtained for blank solutions. The current responses at +0.59 V obtained for ≈4 μmol dm⁻³ ethinylestradiol in 0.1 mol dm⁻³ KCl at both washed and fresh sensors were higher than the current responses at +0.59 V obtained for 0.1% detergent solutions and blanks.

In the study of the effect of detergents towards the electrochemical behavior of the sensors in the detection of ethinylestradiol, the current responses at +0.59 V obtained at washed electrodes (electrodes tested with 0.1% detergent solutions) were compared with the current responses at +0.59 V obtained at fresh electrodes. According to the results, there was no significant different between the current responses at +0.59 V obtained for ≈4 μmol dm⁻³ ethinylestradiol in 0.1 mol dm⁻³ KCl at both washed and fresh electrodes.

It is noted that electrode surface is regenerated during washing due to the removal of retained compounds/deposits on the surface of electrodes. According to the results, 0.1% detergents did not interfere in the determination of ethinylestradiol and also the electrochemical properties of all three electrodes were not affected after washing with 0.1% detergents.

### Example 9. Re-usability.

This experiment studied the electrochemical behavior of the developed electrochemical sensors upon the addition of test sample repeatedly on the same sensor on the same test day. Wearable cotton sensors and laminating paper sensors were tested for their re-usability using real samples.

Two types of test methods were tested on the laminating paper sensor and the wearable cotton sensor. In test Method 1, a Linear Sweep Voltammetry (LSV) technique was used. In test Method 2, both Linear Sweep Voltammetry (LSV) and Cyclic Voltammetry (CV) techniques were used.

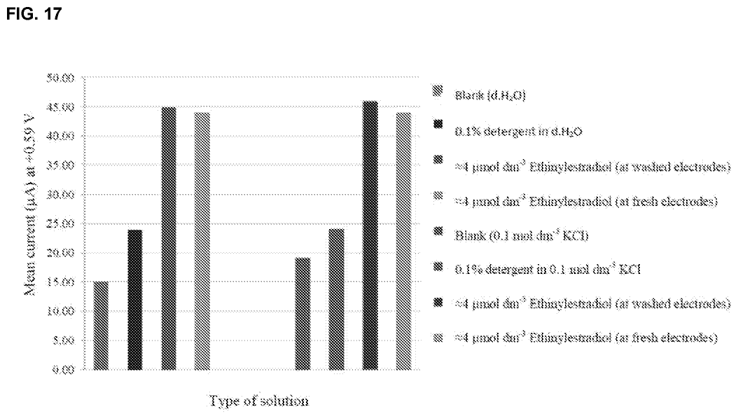

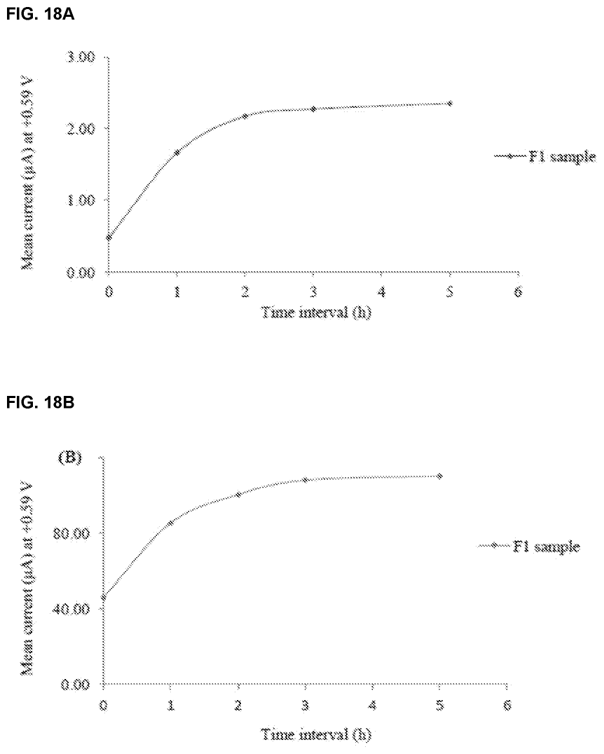

In test Method 1, LSV was used as the analytical technique and the current response obtained at +0.59 V due to the oxidation of estrogen was recorded under optimum LSV conditions using the same sensor in each time interval. Results are shown in Table 15 and FIGS. 18A-18B.

TABLE 15
Mean current at +0.59 V obtained
(in test Method 1) for real sample on
laminating paper sensor and wearable
cotton sensor in different time intervals
under optimum LSV conditions.
(LSV conditions; E_{acc}: +0.10 V
t_{acc}: 1 min, Eᵢₙᵢₜᵢₐₗ: −0.10 V,
E_{final}: +1.00 V,
scan rate: 100 mV s⁻¹)
(n = 3).

| | Mean current | | | |
|---|---|---|---|---|
| | (μA) at +0.59 V | | | |
| Time | Laminating | | Wearable | |
| interval | paper sensor | | cotton sensor | |
| Initial | 0.48 | (±0.03) | 45.75 | (±2.18) |
| After 1 h | 1.66 | (±0.41) | 85.44 | (±3.40) |
| After 2 h | 2.17 | (±0.28) | 100.44 | (±3.66) |
| After 3 h | 2.27 | (±0.51) | 108.20 | (±3.57) |
| After 5 h | 2.35 | (±0.38) | 110.36 | (±3.63) |

According to the results, when adding a constant sample volume on to the sensor repeatedly, the current response increased in each time interval. Current response significantly increased after the addition of sample after 1 h and 2 h. It was found that, after performing LSV, all estrogen did not get oxidized at the working electrode and was retained on the surface of the working electrode. In each addition of the sample on to the sensor repeatedly, more estrogen was adsorbed on the surface of the working electrode and thereby increased the current response. However, after 3 h and 5 h, the increment was less, and tended to be stable. This may have been due to saturation of estrogen at the electrode surface.

Based on the results, the current response increased each time when real sample was introduced on to the same sensor. Therefore, a method optimization was done.

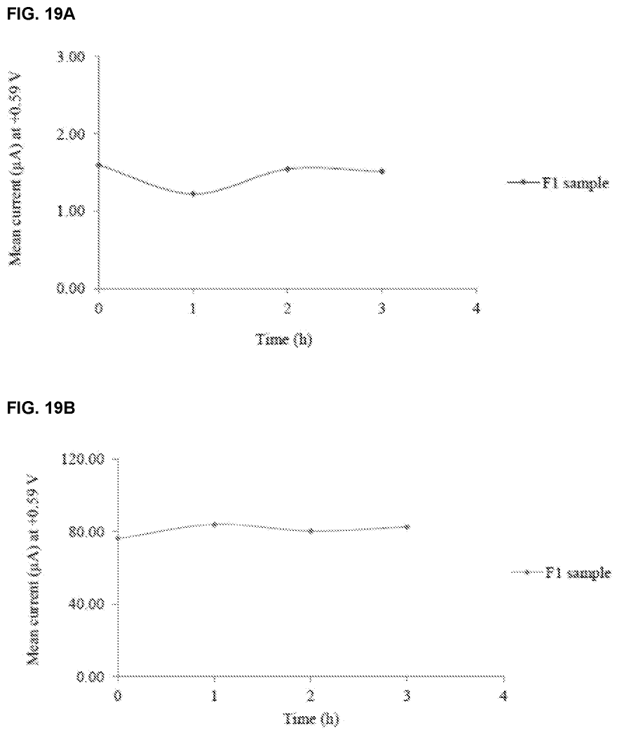

Test Method 2 consists of two steps including LSV as the analytical technique to record current response at +0.59 V and CV technique as a pre-treatment method before the addition of the sample on the same electrochemical sensor. The results obtained for test method 2 are shown in Table 16 and FIGS. 19A-19B.

TABLE 16
Mean current at +0.59 V obtained
(in test Method 1) for real sample on
laminating paper sensor and wearable
cotton sensor in different time intervals
under optimum LSV conditions.
(LSV conditions; E_{acc}: +0.10 V
t_{acc}: 1 min, Eᵢₙᵢₜᵢₐₗ: −0.10 V,
E_{final}: +1.00 V,
scan rate: 100 mV s⁻¹)
(n = 3).

| | Mean current (μA) | | | |
|---|---|---|---|---|
| | at +0.59 V | | | |
| | Laminating | | Wearable | |
| Time | paper | | cotton | |
| interval | sensor | | sensor | |
| Initial | 1.59 | (±0.30) | 76.17 | (±4.53) |
| After 1 h | 1.22 | (±0.32) | 83.85 | (±4.82) |
| After 2 h | 1.54 | (±0.54) | 80.27 | (±2.65) |
| After 3 h | 1.51 | (±0.21) | 82.49 | (±6.91) |

In the first step of test Method 2, LSV was used as the analytical technique and current response obtained at +0.59 V due to the oxidation of estrogen was recorded under optimum LSV conditions. In the second step, CV technique was used as a pre-treatment method to oxidize the estrogen which was retained on the electrode surface after performing LSV.

According to the results in test Method 2, when adding a constant sample volume on the same sensor repeatedly in each time interval, the current response changed very slowly. It was found that, after performing 25 cycles in CV, a noise was obtained at +0.59 V due to the absence of estrogen on the surface of the working electrode. After performing LSV, all estrogen did not get oxidized at the working electrode and retained on the surface of the working electrode. In the pre-treatment step, 25 cycles were performed in CV to oxidize the estrogen, which was retained on the surface of the working electrode and thereby decreased the amount of estrogen on the electrode surface. Therefore, the current response change was negligible in each time interval due to the application of the pre-treatment method prior to the addition of sample on the same sensor.

It is noted that the number of cycles performed in the CV during the pre-treatment method may depend on the amount of estrogen. In these experiments, better results were obtained in test Method 2 due to the application of a pre-treatment prior to the repeated addition of sample on the same sensor. Therefore, both laminating paper sensor and wearable cotton sensor can be re-used.

In summary, the above examples indicate that a modified working electrode can be used for the detection of the variation of estrogen levels associated with the menstrual cycle in urine. This modified wearable cotton sensor was thus developed for integration into fabric. Based on the requirements for integration into garment materials, several modifications were made to the electrochemical sensor developed at lab scale (laminating paper sensor).

In the development of the novel sensor, Thermoplastic polyurethane (TPU) coated fabric was used for two purposes. One purpose was use of TPU coated fabric as the matrix to fabricate working and counter electrode materials. The other purpose was use as the sensor platform. In the sensor platform, TPU was used to create the hydrophobic region on the fabric. This hydrophobic region forms a physical barrier to retain the samples and reagents in the detection zone and prevent the overflow of the volumes.

Sensors were constructed using 5 mmol dm⁻³ CTAB modified graphite-(polyurethane-crosslink 2:1 w/w) 4:2 (w/w) paste working electrode (R<1.0 kΩ/cm) and graphite-(polyurethane-crosslink 2:1 w/w) 4:4 (w/w) paste counter electrode (R<1.0 kΩ/cm). Conductive Ag fabric, which is used in the textile industry, was used as the pseudo reference electrode. Cotton fabric (95% cotton) was placed on the detection zone of the nonenyzmatic electrode system as a sample introducing region which is hydrophilic, to generate a uniform flow of reagents and samples to the electrodes.

Real sample analysis was done by monitoring the pattern of the variation of the current response obtained at +0.59 V due to the oxidation of estrogen at the wearable cotton sensor. Based on the experimental results, the pattern of the variation of the current response obtained for real samples at this sensor was similar to the pattern of the variation of the estrogen level in urine during the menstrual cycle. Lower current response was obtained before the end of the cycle, which indicates the low level of the estrogen level in urine and high current response corresponds to the ovulation. 5 mmol dm⁻³ CTAB modified graphite-(polyurethane-crosslink 2:1) 4:2 paste working electrode is suitable to construct the working electrode due to the ease of preparation of the CTAB modified working electrode material, ease of application of this electrode material on TPU coated cotton fabric in industrial application, and low resistance of both modified working and counter electrode materials.

In the studies of the washing stability of the sensors it was shown that the wearable cotton sensor was washing stable with detergents (0.1% detergent). Moreover, it was shown to be re-usable.

The results indicate that the developed electrochemical sensor with 5 mmol dm⁻³ CTAB modified working electrode can be used for the detection of the variation of the estrogen level associated with the menstrual cycle in urine.

Methodology for the above examples.

Working electrode materials. A concentration series of CTAB (10, 5, 0.10, and 0.08 mmol dm⁻³) was prepared using double-distilled water. Graphite powder and CTAB (10 mmol dm⁻³) (6:5 w/v) were mixed well and it was allowed to stand for 3-4 h. CTAB modified graphite and commercially available varnish (graphite : varnish 2:1 w/w) were mixed using a motor and pestle until obtaining a homogenous paste. CTAB modified carbon pastes containing different concentrations of CTAB (5, 0.10, and 0.08 mmol dm⁻³) were prepared using the same method.

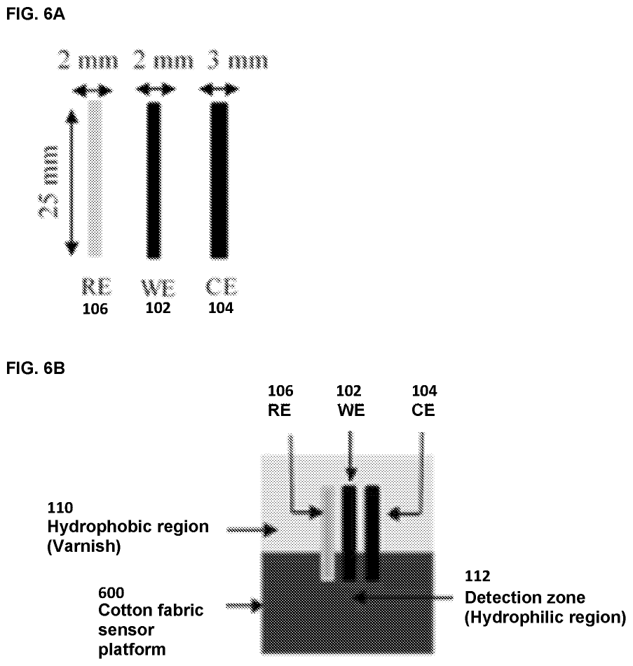

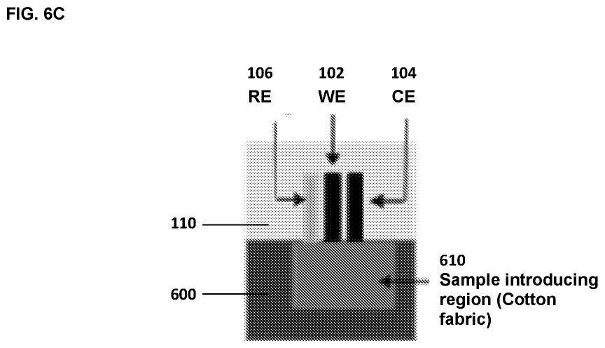

Laminating paper electrodes were cut according to the dimensions in FIG. 6A. The electrode materials were fabricated on laminating paper electrodes and pasted on a cotton fabric sensor platform 600 (FIG. 6B). Cotton fabric was pasted on the detection zone as the sample introducing region 610.

Both unmodified and 5 mmol dm⁻³ CTAB modified working electrodes were tested for ethinylestradiol solution (≈4 μmol dm⁻³, 20 μl) and blank (0.1 mol dm⁻³ KCl, 20 μl) using Cyclic Voltammetry in the potential range +0.10 V to +1.00 V with 100 mV s⁻¹ scan rate.

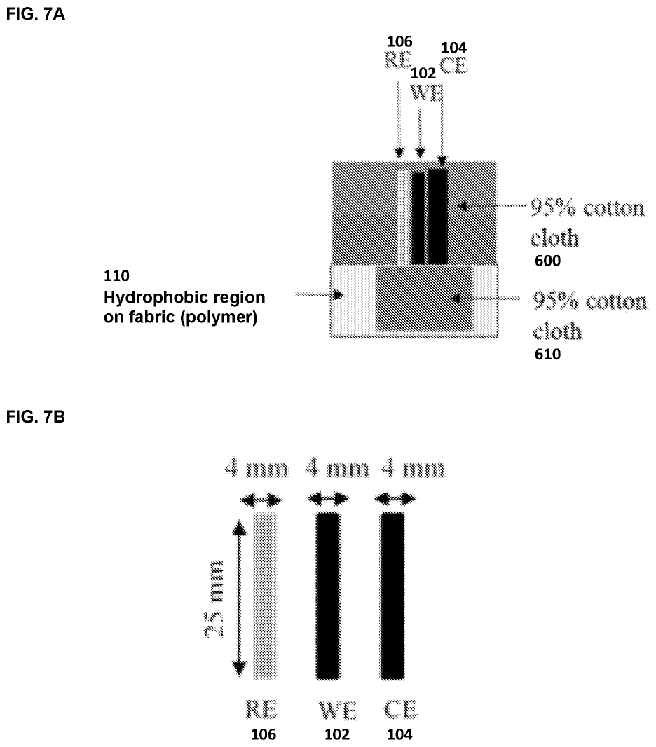

Wearable cotton sensor working electrode materials. Unmodified working electrode was constructed using graphite to (polyurethane-crosslink 2:1 w/w) binder 4:3 (w/w) paste. Modified working electrodes were constructed using 5 mmol dm⁻³ CTAB modified graphite to (polyurethane-crosslink 2:1 w/w) binder 4:4, 4:3, and 4:2 (w/w) pastes. Counter and pseudo reference electrodes were constructed using graphite-(polyurethane-crosslink 2:1 w/w) binder 4:4 (w/w) paste and conductive Ag fabric, respectively. Working and counter electrode materials were fabricated on thermoplastic polyurethane (TPU) coated cotton fabric and heat pressed at a temperature of 140° C. for 90 seconds (s) with a pressure of 5 bars. Polymer (TPU) coating was used to create the hydrophobic region on the cotton fabric sensor platform (FIG. 7A). All electrodes were cut according to the dimensions in FIG. 7B and pasted on the cotton fabric sensor platform 600. Cotton fabric was pasted on the detection zone as the sample introducing region 610.

Both unmodified and 5 mmol dm⁻³ CTAB modified working electrodes were tested for ethinylestradiol solution (≈4 μmol dm⁻³, 80 μl) and blank (0.1 mol dm⁻³ KCl, 80 μl) using LSV under optimum conditions.

Analysis of F1, SPEC SD, and SPEC RS samples. All samples were collected every week day (morning) except weekends and holidays and samples were tested on the collection day. Real sample (80 μl and 40 μl) was added onto the sample introducing region of the wearable cotton sensor and laminating paper sensor, respectively. Current response obtained at +0.59 V was recorded by performing LSV using optimized parameters. F1, SPEC SD and SPEC RS samples were analyzed using the above procedure.

Validation of the wearable electrochemical sensors: A. Construction of the calibration plot. Ethinylestradiol stock solution (≈20 μmol dm⁻³) was prepared using ethinylestradiol containing tablet extraction. A concentration series of ethinylestradiol (≈0.2, 0.6, 1, 2, 4, 8, 12, and 16 μmol dm⁻³) was prepared using ethinylestradiol stock solution ≈20 μmol dm⁻³. Ethinylestradiol (80 μl) from each solution and blank solution (80 μl, 0.1 mol dm⁻³) were added on to the sample introducing region of the wearable cotton sensor and performed LSV under optimum conditions. Current response at +0.59 V obtained for each sample was recorded.

B. Determination of LOD and LOQ. Ten independent blank samples (0.50 ml, 0.1 mol dm⁻³) were spiked with the lowest ethinylestradiol concentration ≈1 μmol dm⁻³ (2.00 ml). From each sample 80 μl was introduced on to the sample introducing region of the wearable cotton sensor and LSV was performed under optimum conditions. Current response at +0.59 V obtained for each sample was recorded.

C. Determination of precision and repeatability. Ten repeated analyses were performed using ethinylestradiol solutions (≈4 μmol dm⁻³) by introducing ethinylestradiol solution (80 μl) on the sample introducing region of the wearable cotton sensor. LSV was performed under optimum conditions and current response at +0.59 V was recorded.

Washing stability of wearable cotton sensor with detergents. The sensor was dipped in 0.1% detergent solution (w/v) and mechanical stirring was done for 1 min. The sensor was then washed with tap water for 2 min. Washed sensors were allowed to dry at room temperature for 24 hours (h) before the analysis of samples.

F1 sample (80 μl) was added onto both fresh sensors and washed sensors. Current response at +0.59 V was recorded by performing LSV using optimized parameters.

Washing stability of the laminating paper sensor with detergents. The sensor was dipped in 0.1% detergent solution (w/v) for 1 min and washed with tap water for 2 min. Washed sensors were allowed to dry at room temperature for 24 h before the analysis of samples.

F1 sample (40 μl) was added onto both fresh sensors and washed sensors. Current response at +0.59 V was recorded by performing LSV using optimized parameters.

Effect of detergents towards the electrochemical behavior of the wearable cotton sensor.

0.1% detergent in distilled water (80 μl) was added on to the sample introducing region of the electrochemical sensor and Linear Sweep Voltammetry (LSV) was performed under optimum conditions. Current response at +0.59 V was recorded. The same procedure was done using 0.1% detergent in 0.1 mol dm⁻³ KCl and blank solutions.

Sensors were washed with tap water for 2 min. Washed sensors were allowed to dry at room temperature for 24 h. After 24 h, each sensor was tested using ≈4 μmol dm⁻³ ethinylestradiol in 0.1 mol dm⁻³ KCl (80 μl) under optimum LSV conditions and current responses at +0.59 V were recorded. Fresh electrodes were tested using ≈4 μmol dm⁻³ ethinylestradiol in 0.1 mol dm⁻³ KCl (80 μl) under optimum LSV conditions and current responses at +0.59 V were recorded.

Re-usability of wearable cotton sensor and laminating paper sensor:

Method 1. Testing the re-usability of the electrochemical sensor under optimum LSV conditions. F1 samples (40 μl and 80 μl) were added on to the sample introducing region of the laminating paper sensor and wearable cotton sensor, respectively. Current response obtained at +0.59 V was recorded by performing LSV using optimized parameters. The same procedure was done after 1 h, 2 h, 3 h, and 5 h using the same sensor.

Method 2. Optimization of the-usability test method. F1 samples (40 μl and 80 μl) were added on to the sample introducing region of the laminating paper sensor and wearable cotton sensor, respectively. Current response obtained at +0.59 V was recorded by performing LSV using optimized parameters. After completion of LSV, CV was performed under optimum CV conditions with repeated number of cycles (25). The same procedure was done after 1 h, 2 h, and 3 h using the same sensors.

### Example 10. Use of Nonenzymatic Electrochemical Sensor for Predicting Events Associated with the Menstruation Cycle

Data Analysis for first test subject (F1). Urine samples were collected from a healthy female (F1) for six consecutive months. The resultant data for cycles 2, 3 and 4 are shown in FIG. 20. Each collected sample was triplicated and the average current at 0.59 V was used to obtain the data shown in FIG. 20, which shows the mean observed for the urine of a healthy female for 3 consecutive months at +0.59V. The data collected for the first cycle was incomplete and is not indicated in the figure. The data for the second, third and fourth cycles clearly indicate a sharp peak at the middle of the cycle (it should be noted that a data point (day 14) is missing in cycle 2 and 3, however the data still clearly indicates a peak in that area) and a broader peak at the middle of the second half of the cycle.

Use of Data to predict an event in a future cycle. As observed in FIG. 20, a healthy individual shows a similar pattern every month. The pattern observed in the first month can be correlated with the actual events that occurred. Looking at the cycle, it was seen that the end of the broader peak could be linked with the end of the cycle (menstruation). This pattern can thus be used to identify the end of the cycle for this individual and alert the user. Likewise, the pattern observed in the first month can be used to link events related to the observed pattern of the second month. In addition, the sharp peak in the middle was associated with ovulation.

Based on the data collected, the ovulation and menstruation can be predicted using the device and the user can be informed accordingly.

Use of Data to alert the user to any physiological changes. A healthy individual generally has the same repetitive levels of hormones from one cycle to the next cycle. Any change in levels or shift of a peak can be due to a hormone imbalance or a medical condition. Since the level of hormones is detected continuously, this device can be used as an early detection system to warn the user to seek medical advice.

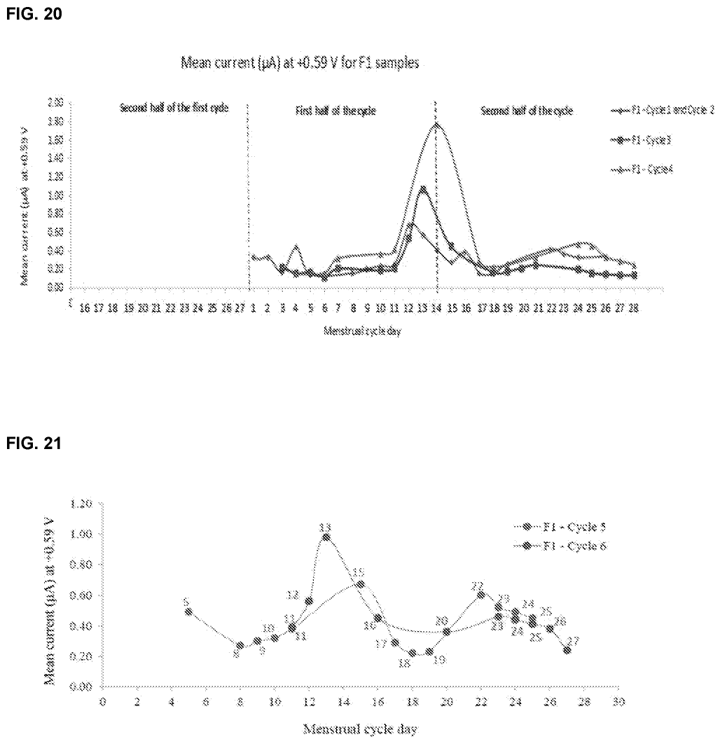

For the F1 subject, the fifth and sixth cycles are shown in FIG. 21. Similar to the first three cycles, both these cycles showed sharp peaks between day 12 and 16, and this feature was correlated with ovulation, while broader peaks at the end of the cycle indicated menstruation.

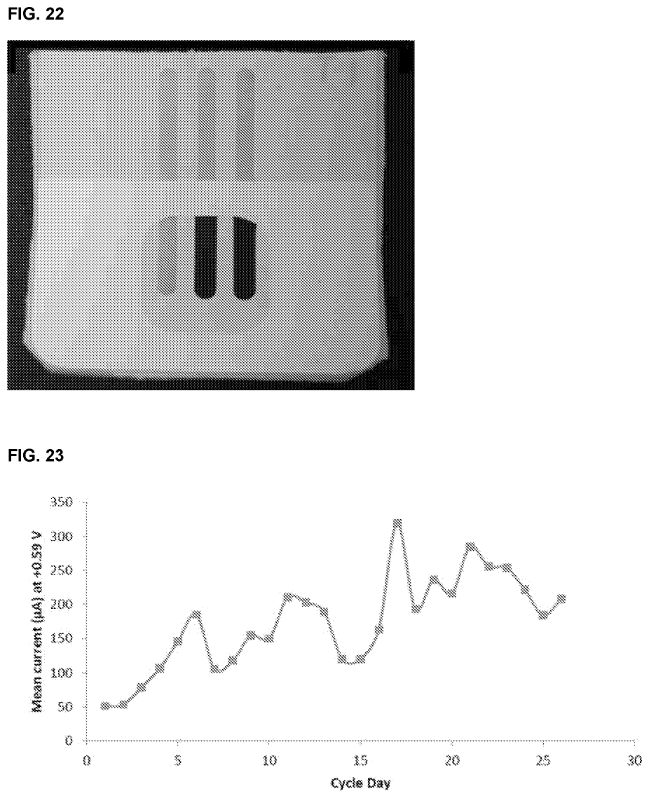

Data Analysis for second test subject (F2). A screen printed device as shown in FIG. 22 was used to collect data from samples collected from the test subject. The working electrode of this device was modified with CTAB. A silver pseudo reference electrode with a carbon-based auxiliary electrode were used as the other two electrodes for this device.

The mean current collected at +0.59V for the test subject F2 is shown in FIG. 23. A sharp peak at day 17 (which correlated with ovulation) and a broader peak at the end of the cycle (which correlated with menstruation) were observed in this test subject also.

### Example 11. A Nonenzymatic Hydration Sensor for Body Fluids

A nonenzymatic electrochemical sensor for the detection of hydration level in human sweat was developed. In this example the sensor is also non-invasive and wearable. Specifically, a wearable sensor platform applicable to garment items for the detection of hydration level in human sweat was prepared.

In endurance sport activities, dehydration and over-hydration are serious health concerns. Therefore, real-time hydration monitoring during a sporting event could act as a preventative therapy, allowing personalized, real-time feedback in order to prevent hydration-related injuries. A conductivity sensor is introduced here which can provide information on the hydration level of an individual based on the conductivity of sweat. Sweat consists mainly of water, salts, lactic acid, glucose, and urea. The electrolytes available in sweat provide a conductivity value to sweat, which under normal physiological conditions remains at 40 mM. The conductivity value increases when dehydrated with a salt concentration above 47.9 mM and decreases when overhydrated with a salt concentration below 26.5 mM (Zhou Y. et al., Materials & design 2016, 90: 1181-1185).

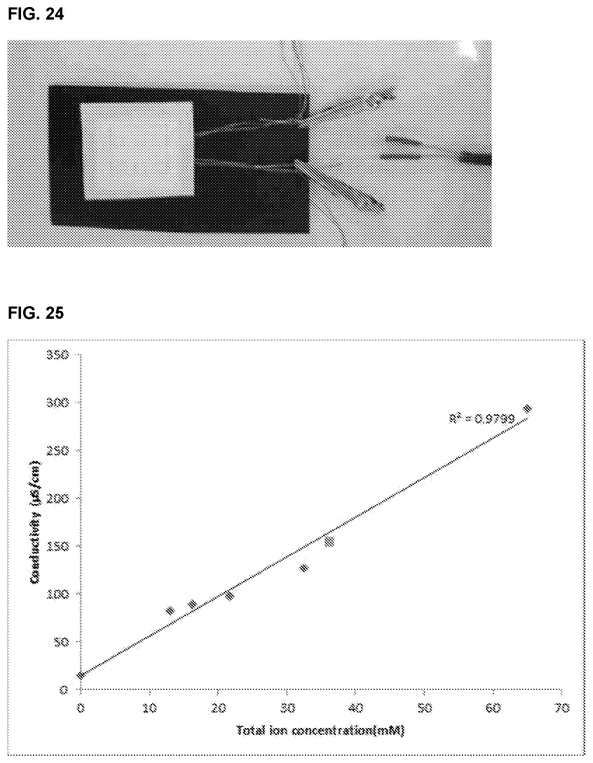

Sensor device. Conductive Ag fabric was used to cut out the two working electrodes (0.5 cm×1.5 cm). Both electrodes were pasted on a cotton fabric 1 cm apart. A second cotton fabric was pasted on top. This sensor device is shown in FIG. 24.

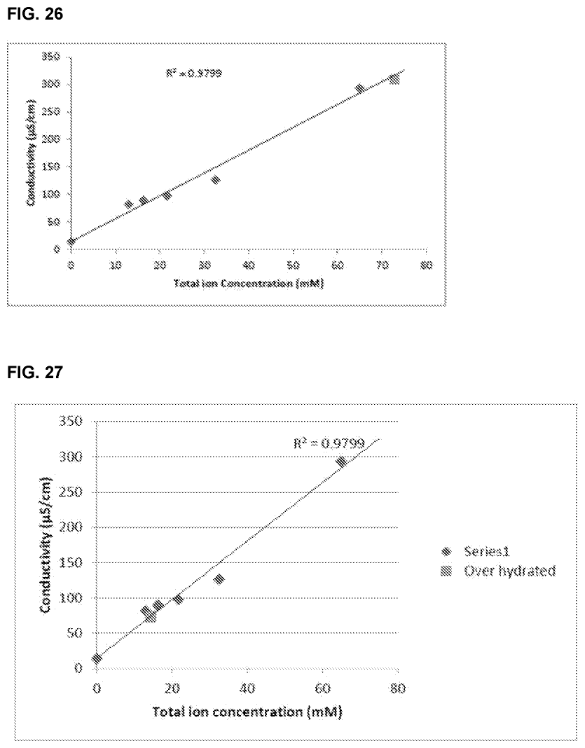

The sensor was calibrated using artificial sweat (Composition: ((W/V)0.5% NaCl+0.1% KCI+0.1% lactic acid+0.1% urea in deionized water) having varying ion concentration (by varying NaCl amount) between 0 to 65 mM. This calibration plot was used to detect the ion concentration of an individual under normal (after consuming 0.7 L of water), overhydrated (approximately 2.0 L of water consumed) and dehydrated (consumed only 300 mL of water during the period between 12 am to 12 pm) conditions. The results are shown FIGS. 25-27.

As can be observed in FIGS. 25-27, the conductivity of the sweat changes according to the hydration level of the individual. The conductivity and salt level in the sweat of a normally hydrated individual is 154 μS/cm, 36.4 mM; for a dehydrated individual, 308 μS/cm, 72.8 mM; and for an overly hydrated individual, 74 μS/cm, 14.3 mM. The conductivity level matches with the salt levels in the literature corresponding to the differently hydrated conditions.

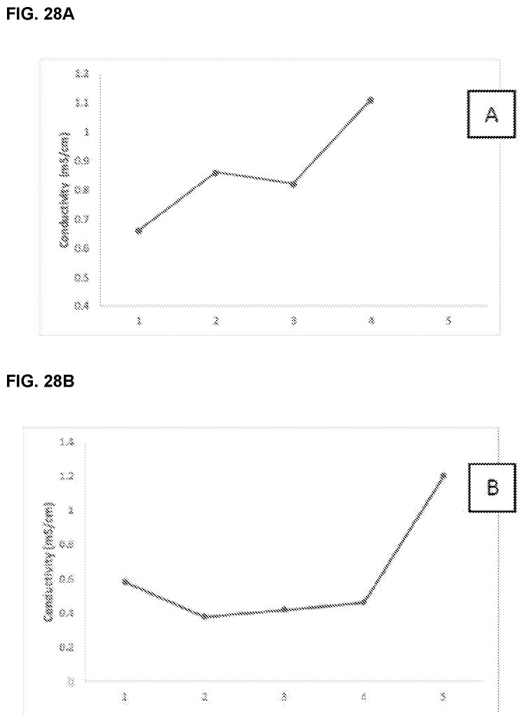

Continuous monitoring of conductivity of sweat of selected individuals. Using two different test subjects, sweat was collected under normal conditions for four days and under dehydrated conditions on the fifth day. Results obtained for Test subjects 01 and 02 are shown in FIGS. 28A and 28B.

FIGS. 28A and 28B show the conductivity variation of the sweat of an individual from a normal condition to a dehydrated condition. FIG. 28A shows conductivity variation for Test subject 01, whose average conductivity under normal conditions (within the first 4 days) was obtained as 0.46 mS/cm. For the same individual under dehydrated conditions, the conductivity increased up to 1.2 mS/cm (on the fifth day). FIG. 28B shows conductivity variation for Test subject 02, whose average conductivity under normal conditions (within the first 4 days) was obtained as 0.78 mS/cm. For the same individual under dehydrated conditions, the conductivity increased up to 1.1 mS/cm (on the fifth day). These results show that data collected on average sweat conductivity of an individual can be used to monitor the individual's hydration status and to alert the individual to an approaching dehydration condition.

### Example 12. A Nonenzymatic Glucose Sensor for Determination of Glucose in Saliva

The level of glucose in various biological fluids can be used as an indicator to diagnose and monitor diabetic conditions. Most common electrochemical sensors are based on enzymatic working electrodes. However, a major disadvantage of enzyme-based electrodes is instability. As an alternative, stable nonenzymatic electrochemical methods can be used to detect the glucose level under field conditions.

Copper was used in this research to construct a nonenzymatic glucose sensor because its CuO form shows the most favorable signal-to-noise (S/N) characteristics compared to other metal electrodes such as Nickel. In addition, copper is relatively inexpensive and readily available.

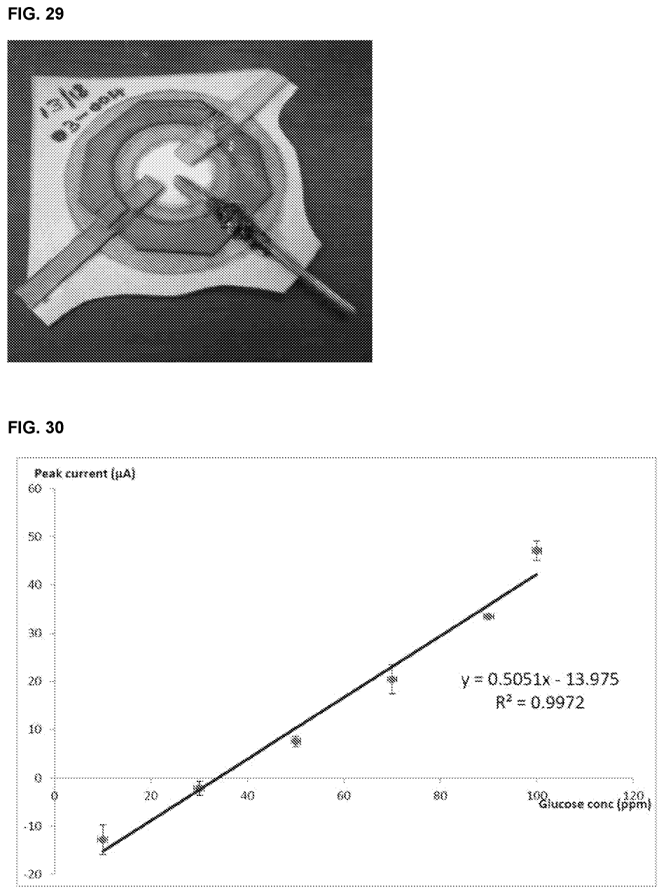

Sensor Device. The level of glucose in saliva was detected using a three-electrode system. Copper wire modified with CuO was used as the working electrode, Ag conductive fabric was used as the pseudo reference electrode and the counter electrode. A laboratory-scale prototype is shown in FIG. 29.

Validation of the electrochemical sensor was done using cyclic voltammetry by monitoring the current response obtained due to the oxidation of glucose at +0.3 V in basic medium at the CuO/Cu working electrode. The calibration plot is shown in FIG. 30.

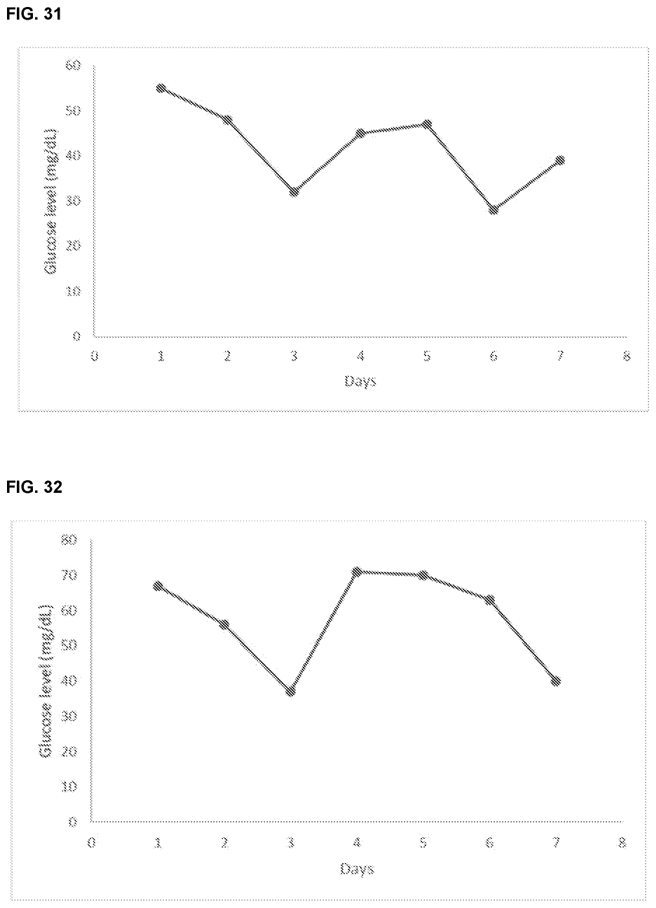

Monitoring glucose levels in saliva. The developed sensor was used to detect the glucose level in two healthy test subjects (under non-fasting conditions). The variations of the detected glucose levels in consecutive days are shown in FIGS. 31 and 32. Both figures show minute variations in the level of glucose with time, and no drastic variations were observed within the test period.

It has been suggested previously that there is a correlation between blood glucose and the saliva glucose under fasting conditions (Zhang, W. et al., Sens. Bio-Sensing Res. 2015, 4: 23-29). The noninvasive sensor described here can be used to monitor glucose levels continuously in saliva to detect and alert any drastic changes to the user. Such changes may be associated with life-threatening, health-related conditions.

Although this invention is described in detail with reference to embodiments thereof, these embodiments are offered to illustrate but not to limit the invention. It is possible to make other embodiments that employ the principles of the invention and that fall within its spirit and scope as defined by the claims appended hereto.

The contents of all documents and references cited herein are hereby incorporated by reference in their entirety.

1. A nonselective, nonenzymatic electrochemical sensor system for predicting a physiological event or monitoring biological changes in a subject based on detection and/or measurement of an analyte in a sample, the electrochemical sensor system comprising :
a substrate; and
a nonenzymatic electrode system that does not use enzymes disposed on the substrate, the nonenyzmatic electrode system comprising :
i) at least one working electrode (WE), the WE being electrochemically inert and conductive in a selected voltage range under which the analyte undergoes oxidation or reduction, the WE being configured to oxidize or reduce the analyte in the selected voltage range and thereby produce a current, the WE comprising a nonenzymatic modifier to increase sensitivity and/or selectivity of the WE for the analyte;
ii) at least one counter electrode (CE), the CE being electrochemically inert and conductive in the selected voltage range, the CE being configured to complete a current path for the current produced by the WE; and
iii) a reference electrode (RE), the RE being electrochemically inert and conductive in the selected voltage range, the RE being configured for use as a reference point;
wherein the current produced by the nonenyzmatic electrode system in the selected voltage range is proportional to the amount of the analyte in the sample;
wherein the analyte is a biomarker, a hormone, a metabolite, a sugar, a protein, a peptide, a nucleic acid, an alcohol, an electrolyte, or a low molecular weight chemical compound;
wherein the sample is collected automatically or involuntarily, without first isolating the sample from the subject;
wherein the electrochemical sensor system is configured to measure levels of the analyte in the sample at predetermined time intervals to establish a baseline or calibration curve for the subject based on the levels of the analyte at the predetermined time intervals, and, after the baseline or calibration curve is established, to continue to measure the level of the analyte in the subject,
wherein comparison of the measured level to the baseline or calibration curve predicts said physiological event or monitors said biological changes in the subject;
wherein the electrochemical sensor system is reusable, washable in the presence or absence of a detergent, and non-invasive.

2. The electrochemical sensor system of claim 1, wherein the nonenzymatic modifier is a surfactant or a metal oxide.

3. The electrochemical sensor system of claim 1, wherein the WE, the CE and the RE are independently in the form of wires, a sheet, a powder, a powder mixed with an adhesive, a fiber, a thread, yarn or a fabric.

4. The electrochemical sensor system of claim 1, wherein the nonenyzmatic electrode system further comprises a fourth electrode (FE), the FE being electrochemically inert and conductive in the selected voltage range, the FE being configured for (i) electrochemical generation of reagents and/or conditions required for oxidation or reduction of the analyte, (ii) for measuring conductivity of the sample, and/or (iii) for optimizing conditions for oxidation or reduction of the analyte, optionally wherein the FE generates hydroxyl ions.

5. The electrochemical sensor system of claim 1, wherein the RE comprises a stable metal and salt mixture mixed with conductive glue.

6. The electrochemical sensor system of claim 1, wherein the nonenyzmatic electrode system comprises two or more WEs, each of the two or more WEs being configured to detect or measure oxidation or reduction of a first or a second respective analyte, such that the sensor system can detect or measure two or more different analytes in the sample sequentially, wherein the two or more WEs are configured to detect the two or more different analytes using one or more of the following mechanisms:
(i) the two or more WEs each produce current at a first or a second respective electric potential that is selected for the first or the second respective analyte, the first electric potential being specific for the first analyte and the second electric potential being specific for the second analyte; and/or
(ii) the two or more WEs each comprise a first or a second respective nonenzymatic modifier that is selected to increase sensitivity for the first or the second respective analyte, the first nonenzymatic modifier being optimized for the first analyte and the second nonenzymatic modifier being optimized for the second analyte.

7. The electrochemical sensor system of claim 1, wherein the substrate comprises a first layer and a second layer, the first layer having a first nonenyzmatic electrode system disposed thereon, and the second layer having a second nonenyzmatic electrode system disposed thereon, optionally wherein the first nonenyzmatic electrode system comprises a first working electrode configured to detect or measure a first analyte, and the second nonenyzmatic electrode system comprises a second working electrode configured to detect or measure a second analyte.

8. The electrochemical sensor system of claim 1, wherein the analyte is a biomarker, a hormone or an electrolyte selected from estrogen, progesterone, a synthetic estrogen such as ethinylestradiol, a synthetic progestin such as levonorgestrel, cortisol, glucose, uric acid, sodium chloride, and potassium chloride.

9. The electrochemical sensor system of claim 1, wherein the sample is a beverage, a drinkable liquid, water, a culture media, a liquid media, a biological fluid, or a bodily fluid such as urine, sweat, saliva, tears, blood, semen, or interstitial fluid.

10. The electrochemical sensor system of claim 1, wherein the substrate is flexible and/or stretchable.

11. The electrochemical sensor system of claim 1, wherein the substrate is fabric, fiber, thread, yarn, paper, plastic, silicone, or polyurethane, optionally wherein the substrate comprises cotton, wool, nylon, polyester, rayon, neoprene, viscose, modal, microfibers, Tencel® and/or Gore-Tex®.

12. The electrochemical sensor system of claim 11, wherein the substrate comprises about 60%, about 70%, about 80%, about 85%, about 90%, about 95%, or 100% of a moisture absorbing fabric, optionally cotton, optionally coated at least partially with a hydrophobic substance such as a varnish or thermoplastic polyurethane; or of a moisture wicking fabric, optionally modal, microfibers, or a fabric treated with a wicking enhancer.

13. The electrochemical sensor system of claim 1, wherein the sensor system is a wearable cotton sensor, the WE and/or CE comprising cotton fabric.

14. An article comprising one or more electrochemical sensor system as described in claim 1.

15. The article of claim 14, wherein the article is a medical device, a fitness monitor, a personal electronic device, a glucose monitor, a wearable item configured to be worn on a body or on at least one body part of a subject, an electronically operated device, an article of apparel or a garment such as an undergarment, a flexible compression garment, or athletic clothing.

16. The article of claim 11, further comprising one or more additional sensor configured to sense at least one characteristic associated with movement of the subject and/or at least one physiological characteristic of the subject.

17. A method for predicting periodic or cyclical physiological events in a subject, comprising:
using the electrochemical sensor system as defined in claim 1 to measure levels of an analyte at predetermined time intervals;
establishing a baseline or calibration curve for the subject based on the levels of the analyte at the predetermined time intervals; and
after establishing the baseline or calibration curve, continuing to measure the levels of the analyte in the subject at predetermined time intervals;
wherein comparison of measured levels to the baseline or calibration curve is used to predict periodic or cyclical physiological events in the subject, optionally wherein the analyte is a hormone and the periodic or cyclical physiological event is ovulation or menstruation.

18. A method for detecting or diagnosing an unexpected physiological event in a subject, comprising:
using the electrochemical sensor system as defined in claim 1 to measure levels of an analyte at predetermined time intervals or on an ongoing basis, to determine a baseline level of the analyte in the subject; and
after establishing the baseline level, continuing to measure the levels of the analyte in the subject at predetermined time intervals or on an ongoing basis;
wherein an unexpected change in the levels of the analyte in the subject indicates the unexpected physiological event,
optionally wherein the analyte is glucose and the unexpected physiological event is onset of diabetes, or wherein conductivity value in sweat is measured and the unexpected physiological event is dehydration.

19. A method for predicting events associated with the menstruation cycle in a subject, the method comprising the steps of:
a) measuring a first set of daily levels of an analyte in the subject, using the electrochemical sensor system of claim 1, said daily levels being measured for at least one month, optionally for two, three, four, five or six months, said daily levels being used to establish a calibration curve for the subject;
b) after the calibration curve has been established, measuring daily levels of the analyte in the subject on an ongoing basis, using the electrochemical sensor system of claim 1;
wherein the level of the analyte in the subject is used to predict events associated with the menstruation cycle in the subject, based on the calibration curve, optionally wherein the events are ovulation, menstruation, menopause, or pregnancy.
